(19) United States
(12) Patent Application Publication
(10) Pub. No.: US 2023/0163272 A1
(43) Pub. Date: May 25, 2023

(54) ANODE INTERLAYER FOR ALL- SOLID SECONDARY BATTERY, ALL-SOLID SECONDARY BATTERY COMPRISING ANODE INTERLAYER, AND METHOD OF CHARGING ALL-SOLID SECONDARY BATTERY

(71) Applicant: Samsung Electronics Co., Ltd., Suwon-si (KR)

(72) Inventors: Seungsik Hwang, Seongnam-si (KR); Sewon Kim, Suwon-si (KR); Jusik Kim, Hwaseong-si (KR)

(21) Appl. No.: 17/751,748

(22) Filed: May 24, 2022

(30) Foreign Application Priority Data
Nov. 23, 2021 (KR) 10-2021-0162606

(51) Int. Cl. H01M 4/36; H01M 4/38; H01M 4/485; H01M 4/60; H01M 4/62; H01M 10/0525; H01M 10/0562

(52) U.S. Cl. CPC H01M 4/364; H01M 4/366; H01M 4/38; H01M 4/485; H01M 4/604; H01M 4/622; H01M 4/625; H01M 10/0525; H01M 10/0562; H01M 2004/027

(57) ABSTRACT

An anode interlayer for an all-solid secondary battery includes: an active material capable of undergoing lithiation and delithiation; a first conductive binder; and a second conductive binder, wherein the active material includes carbon or a combination of carbon and a first metal, the first conductive binder includes an ion-conductive polymer, the ion-conductive polymer includes lithium as a substituent, and the second conductive binder includes an electron-conductive polymer.

### CROSS-REFERENCE TO RELATED APPLICATION

This application claims priority to Korean Patent Application No. 10-2021-0162606, filed on Nov. 23, 2021, in the Korean Intellectual Property Office, and all the benefits accruing therefrom under 35 U.S.C. § 119, the content of which is incorporated herein by reference in its entirety.

### BACKGROUND

### 1. Field

The present disclosure relates to an anode interlayer for an all-solid secondary battery, an all-solid secondary battery including the same, and a method of charging the all-solid secondary battery.

### 2. Description of the Related Art

Recently, batteries having high energy density and high safety have been actively developed in accordance with industrial requirements. For example, lithium-ion batteries have been commercially available in the automotive field as well as in the fields of information-associated equipment and communication equipment. In the automotive field, safety of batteries is particularly important due to its association with life.

Currently available lithium-ion batteries use an electrolyte solution including a flammable organic solvent, and thus, there is a risk of overheating and fire when a short-circuit occurs. Accordingly, an all-solid battery using a solid electrolyte instead of such a liquid electrolyte has been suggested.

An all-solid battery does not use a flammable organic solvent, and thus has a reduced risk of fire or explosion even when a short-circuit occurs. Therefore, such an all-solid secondary battery may be much safer than a lithium-ion battery using a liquid electrolyte containing a flammable organic solvent.

### SUMMARY

One or more embodiments include an anode interlayer in which an increase in internal resistance can be suppressed, and in which uniformity of current density and uniformity of lithium ion migration can be improved.

One or more embodiments includes an all-solid secondary battery that includes the anode interlayer described above, so that a short circuit caused by the growth of lithium dendrites during charging and discharging can be suppressed, and high-rate capability and lifespan characteristics can be improved.

Additional aspects will be set forth in part in the description which follows and, in part, will be apparent from the description, or may be learned by practice of the presented embodiments of the disclosure.

According to one or more embodiments, provided is an anode interlayer for an all-solid secondary battery, the anode interlayer including: an active material capable of undergoing lithiation and delithiation; a first conductive binder; and a second conductive binder, wherein the active material includes carbon or a combination of carbon and a first metal, the first conductive binder includes an ion-conductive polymer, wherein the ion-conductive polymer includes lithium as a substituent, and the second conductive binder includes an electron-conductive polymer.

According to one or more embodiments, provided is an all-solid secondary battery including: a cathode layer including a cathode active material layer; an anode layer; and a solid electrolyte layer including a solid electrolyte, the solid electrolyte layer being disposed between the cathode layer and the anode layer, wherein the anode layer includes an anode current collector, and a first anode interlayer between the solid electrolyte layer and the anode current collector, and the first anode interlayer includes the anode interlayer described above.

A method of manufacturing the all-solid secondary battery includes stacking the cathode layer on a laminate of the anode layer and the solid electrolyte layer such that the solid electrolyte layer is disposed between the cathode layer and the anode layer to form a stack; and pressing the stack to manufacture the all-solid secondary battery.

According to one or more embodiments, provided is a method of charging the all-solid secondary battery described above, the method including: charging to exceed a charge capacitance of the first anode interlayer, wherein the all-solid secondary battery is charged so that a lithium precipitation layer precipitated on the anode layer has a thickness of about 1 micron (μm) to about 100 μm.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a cross-sectional view of an embodiment of an all-solid secondary battery;

FIG. 2 is a cross-sectional view of another embodiment of an all-solid secondary battery;

FIG. 3 is a cross-sectional view of yet another embodiment of an all-solid secondary battery; and

FIG. 4 is a cross-sectional view of still another embodiment of an all-solid secondary battery.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

In an all-solid secondary battery of the related art, due to use of a solid electrolyte, lithium can be locally precipitated at the interface between a solid electrolyte layer and an anode layer. The precipitated lithium grows during a charging and discharging process and penetrates or causes cracks to form in the solid electrolyte layer, and thus a short-circuit may occur in the battery. The local precipitation of lithium at the interface between the solid electrolyte layer and the anode layer solid electrolyte layer is caused by non-uniformity of current density and non-uniformity of migration of lithium ions at the interface.

According to one or more embodiments, provided are an anode interlayer and an all-solid secondary battery comprising the anode interlayer, the anode interlayer capable of suppressing increases in internal resistance and improving uniformity of current density and uniformity of lithium ion migration at the interface between a solid electrolyte layer and an anode layer.

The present disclosure will now be described more fully with reference to the accompanying drawings, in which example embodiments are shown. The present disclosure may, however, be embodied in many different forms, should not be construed as being limited to the embodiments set forth herein, and should be construed as including all modifications, equivalents, and alternatives within the scope of the present disclosure; rather, these embodiments are provided so that this disclosure will be thorough and complete, and will fully convey the effects and features of the present disclosure and ways to implement the disclosure to those skilled in the art.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the slash “/” or the term “and/or” includes any and all combinations of one or more of the associated listed items.

In the drawings, the size or thickness of each layer, region, or element are arbitrarily exaggerated or reduced for better understanding or ease of description, and thus the present disclosure is not limited thereto. Throughout the written description and drawings, like reference numbers and labels will be used to denote like or similar elements. It will also be understood that when an element such as a layer, a film, a region or a component is referred to as being “on” another layer or element, it can be “directly on” the other layer or element, or intervening layers, regions, or components may also be present. Although the terms “first”, “second”, etc., may be used herein to describe various elements, components, regions, and/or layers, these elements, components, regions, and/or layers should not be limited by these terms. These terms are used only to distinguish one component from another, not for purposes of limitation. In the following description and drawings, constituent elements having substantially the same functional constitutions are assigned like reference numerals, and overlapping descriptions will be omitted.

“About” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, the term “metal” includes metals, or metalloids such as silicon and germanium, in an atomic state or an ionic state.

As used herein, the term “alloy” refers to a mixture of two or more metals.

As used herein, the terms “lithiation” and “lithiate” means a process of adding lithium to an active material.

As used herein, the term “delithiation” and “delithiate” means a process of removing lithium from an active material.

As used herein, the term “active material” means a material capable of undergoing lithiation and delithiation.

As used herein, the terms “charging” and “charge” means a process of providing electrochemical energy to a battery.

As used herein, the terms “discharging” and “discharge” means a process of removing electrochemical energy from a battery.

As used herein, the term “positive electrode” or “cathode” means an electrode in which electrochemical reduction and lithiation occurs during a discharging process.

As used herein, the term “negative electrode” or “anode” means an electrode in which electrochemical oxidation and delithiation occurs during a discharging process.

As used herein, the term “particle diameter” indicates an average diameter of particles when the particles are spherical, or indicates an average major axis length of particles when the particles are non-spherical. The particle diameter of particles may be measured using a particle size analyzer (PSA). The “particle diameter” may be, for example, an average particle diameter. The average particle diameter is a median particle diameter (D50) unless explicitly described otherwise. The median diameter (D50) is a particle size corresponding to a cumulative value of 50% of smaller particles in a cumulative distribution curve of particle size in which particles are accumulated in the order of particle sizes from the smallest to the largest. The cumulative value may be, for example, a cumulative value. The median particle diameter (D50) may be measured, for example, using laser diffraction.

Hereinafter, embodiments of an anode interlayer for an all-solid secondary battery, an all-solid secondary battery including the same, and a method of charging the all-solid secondary battery will be described in greater detail.

### Anode Interlayer

According to one or more embodiments, an anode interlayer for an all-solid secondary battery includes: a material capable of undergoing lithiation and delithiation; a first conductive binder; and a second conductive binder, wherein the material capable of undergoing lithiation and delithiation includes carbon or a combination of carbon and a first metal, the first conductive binder includes an ion-conductive polymer, the ion-conductive polymer includes lithium as a substituent, and the second conductive binder includes an electron-conductive polymer.

By simultaneously including the first conductive binder as an ion-conductive polymer and the second conductive binder anode interlayer as a second conductive polymer, in the anode interlayer, increases in internal resistance of the anode interlayer may be suppressed. In addition, in the all-solid secondary battery including the anode interlayer, uniformity of the current density and uniformity of mobile ion migration at the interface between the solid electrolyte layer and the anode layer may be improved. Accordingly, increase in the internal resistance of the all-solid secondary battery including the anode interlayer may be suppressed, growth of lithium dendrite may be suppressed, and the all-solid secondary battery may have improved high-rate capability and lifespan characteristic. In addition, the utilization rate of the active material included in the all-solid secondary battery can be improved, and thus, the all-solid secondary battery may have improved energy density.

For example, by including the first conductive binder and the second conductive binder in the anode interlayer, despite a volumetric and/or positional change of the anode interlayer during a charging and discharging process, the formation of cracks in the anode interlayer may be suppressed. For example, in a case where the anode interlayer does not include both the first conductive binder and the second conductive binder as described herein, the anode interlayer may be easily separated from an adjacent layer, for example, the solid electrolyte layer. In a region where the anode interlayer is separated from the solid electrolyte layer, migration of lithium ions and electrons is impossible, thus increasing the internal resistance of the all-solid secondary battery and lowering cycle characteristics. For example, the anode interlayer may be manufactured by coating on the solid electrolyte layer and drying a slurry in which the material capable of undergoing lithiation and delithiation is dispersed. By including the first conductive binder and the second conductive binder in the anode interlayer, the material capable of undergoing lithiation and delithiation may be stably dispersed in the slurry. For example, when the slurry is coated on the solid electrolyte layer or the anode current collector by screen printing, clogging of a screen (for example, clogging by material in particle form) may be suppressed.

The first conductive binder may bind the material capable of undergoing lithiation and delithiation, and thus may improve mechanical strength of the anode interlayer. In addition, since the first conductive binder may improve binding strength between the anode conductive binder and other adjacent layers, durability of the all-solid secondary battery including the anode interlayer may be improved. Accordingly, the all-solid secondary battery including the anode interlayer may have improved lifespan characteristics.

In addition, lithium ions may move more rapidly on the surface than inside the material capable of undergoing lithiation and delithiation. The first conductive binder may form a lithium ion conduction pathway by adhering to the surface of the material capable of undergoing lithiation and delithiation. Accordingly, lithium ions can move more rapidly through the surface of the material capable of undergoing lithiation and delithiation. As a result, the all-solid secondary battery including the anode interlayer may have improved high-rate capability.

The ion-conductive polymer including a lithium substituent may include a lithium-containing functional group. The lithium-containing functional group may be, for example, —C(═O)OLi, —OS(═O)₂OLi, —S(═O)₂OLi, —S(═O)OLi, —OP(═O)(OH)OLi, —OP(═O)(OLi)₂, —P(═O)(OH)OLi, —P(═O)(OLi)₂, or a combination thereof. Since the anode interlayer includes the ion-conductive polymer including such a lithium-containing group, a lithium ion conduction pathway and improved lithium ion conductivity may be obtained. Accordingly, at the interface between the anode layer including the anode interlayer and the solid electrolyte layer, improved uniformity of lithium ion migration may be provided. The ion-conductive polymer may include an acidic functional group. The acidic functional group included in the ion-conduction polymer may be, for example, a functional group including a proton that can be substituted with lithium. The acidic functional group included in the ion-conductive polymer may be, for example, —C(═O)OH, —OS(═O)₂OH, —S(═O)₂OH, —S(═O)OH, —OP(═O)(OH)₂, —P(═O)(OH)₂, or a combination thereof. The amount of the lithium ion-containing functional group included in the ion-conductive polymer may be about 50 mol % to about 100 mol %, about 60 mol % to about 100 mol %, about 70 mol % to about 100 mol %, about 80 mol % to about 100 mol %, or about 90 mol % to about 100 mol % of a total mole number of the acidic functional group included in the ion-conductive polymer. When the ion-conductive polymer includes the lithium-containing functional group within these ranges, solubility of the ion-conductive polymer may be increased, and lithium ion conductivity may be further improved. The ion-conductive polymer including a lithium substituent may be a water-soluble and/or water-dispersible polymer.

For example, the ion-conductive polymer may include a first repeating unit represented by Formula 1 or a second repeating unit represented by Formula 2:

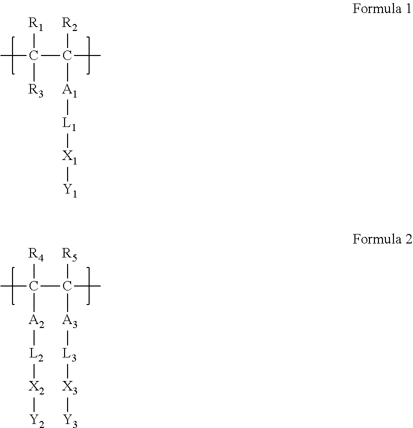

wherein, in Formulae 1 and 2,

A₁, A₂, and A₃ are each independently a single bond or —(C═O)—N(Ra)—,

L₁, L₂, and L₃ are each independently a single bond, or a substituted or unsubstituted C1-C30 alkylene group, a substituted or unsubstituted C2-C30 alkenylene group, a substituted or unsubstituted C2-C30 alkynylene group, a substituted or unsubstituted C6-C30 arylene group, a substituted or unsubstituted C7-C30 arylalkylene group, a substituted or unsubstituted C2-C30 heteroarylene group, a substituted or unsubstituted C3-C30 heteroarylalkylene group, a substituted or unsubstituted C4-C30 carbocyclic group, a substituted or unsubstituted C5-C30 carbocyclic alkylene group, a substituted or unsubstituted C2-C30 heterocyclic group, or a substituted or unsubstituted C3-C30 heterocyclic alkylene group,

R₁, R₂, R₃, R₄, R₅, and Ra are each independently a hydrogen atom, a substituted or unsubstituted C1-C30 alkyl group, a substituted or unsubstituted C1-C30 alkoxy group, a substituted or unsubstituted C1-C30 alkylthio group, a substituted or unsubstituted C2-C30 alkenyl group, a substituted or unsubstituted C2-C30 alkynyl group, a substituted or unsubstituted C6-C30 aryl group, a substituted or unsubstituted C6-C30 aryloxy group, a substituted or unsubstituted C7-C30 arylalkyl group, a substituted or unsubstituted C7-C30 alkylaryl group, a substituted or unsubstituted C2-C30 heteroaryl group, a substituted or unsubstituted C2-C30 heteroaryloxy group, a substituted or unsubstituted C3-C30 heteroarylalkyl group, a substituted or unsubstituted C3-C30 alkylheteroaryl group, a substituted or unsubstituted C4-C30 carbocyclic group, a substituted or unsubstituted C5-C30 carbocyclic alkyl group, a substituted or unsubstituted C2-C30 heterocyclic group, or a substituted or unsubstituted C2-C30 heterocyclic alkyl group, and

X₁, X₂, and X₃ are each independently —C(═O)O—, —OS(═O)₂O—, —S(═O)₂O—, —S(═O)O—, —OP(═O)(OY)O—, or —P(═O)(OY)O—, and

Y₁ is lithium, and Y, Y₂ and Y₃ are each independently a hydrogen atom, an alkali metal, or an ammonium group,

with the proviso that at least one of Y₂ and Y₃ is lithium.

In Formulae 1 and 2, as described above, for example, X₁, X₂, and X₃ are each independently a carboxylate group (—C(═O)O—), a sulfate group (—OS(═O)₂O—), a sulfonic group (—S(═O)₂O—), a sulfinate group (—S(═O)O—), a phosphate group (—OP(═O)(OY)O—), or a phosphonate group (—P(═O)(OY)O—).

In Formulae 1 and 2, when X₁, X₂, and X₃ are each independently a phosphate group or a phosphonate group, —X₁—Y₁ are each independently one of the groups represented by Structural Formulae 1 and 2, —X₂—Y₂ are each independently one of the groups represented by Structural Formulae 3 and 4, and —X₃—Y₃ are each independently one of the group represented by Structural Formulae 5 and 6:

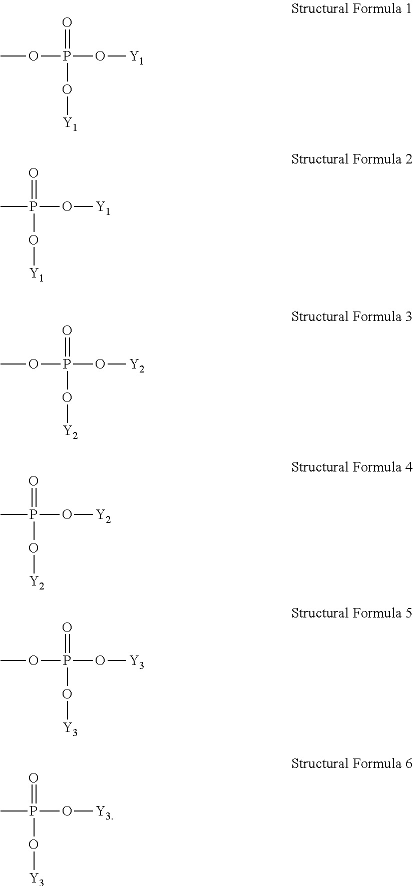

Since the ion-conductive polymer includes the first repeating unit represented by Formula 1 or a second repeating unit represented by Formula 2, the ion-conductive polymer may provide improved ionic conductivity.

For example, the ion-conductive polymer may include a first repeating unit represented by Formula 3, 4, or 5, or a second repeating unit represented by Formula 6:

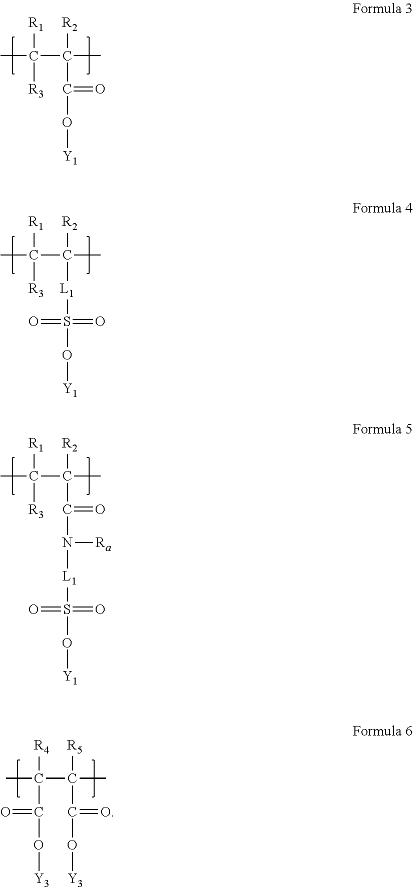

In formulae 3-6, R1, R₂, R₃, R₄, R₅, and Ra are each independently a hydrogen atom, a substituted or unsubstituted C1-C30 alkyl group, a substituted or unsubstituted C1-C30 alkoxy group, a substituted or unsubstituted C2-C30 alkenyl group, a substituted or unsubstituted C2-C30 alkynyl group, a substituted or unsubstituted C6-C30 aryl group, a substituted or unsubstituted C6-C30 aryloxy group, a substituted or unsubstituted C7-C30 arylalkyl group, a substituted or unsubstituted C2-C30 heteroaryl group, a substituted or unsubstituted C2-C30 heteroaryloxy group, a substituted or unsubstituted C3-C30 heteroarylalkyl group, a substituted or unsubstituted C4-C30 carbocyclic group, a substituted or unsubstituted C5-C30 carbocyclic alkyl group, a substituted or unsubstituted C2-C30 heterocyclic group, or a substituted or unsubstituted C2-C30 heterocyclic alkyl group, and

Y₁ is lithium, and Y₂ and Y₃ are each independently a hydrogen atom, an alkali metal, or an ammonium group,

with the proviso that at least one of Y₂ and Y₃ is lithium.

For example, the ion-conductive polymer may further include a third repeating unit represented by Formula 7, a fourth repeating unit represented by Formula 8, or a combination thereof:

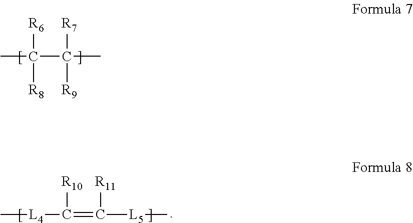

In Formulae 7 and 8,

L₄ and L₅ are each independently a single bond, or a substituted or unsubstituted C1-C30 alkylene group, a substituted or unsubstituted C2-C30 alkenylene group, a substituted or unsubstituted C2-C30 alkynylene group, a substituted or unsubstituted C6-C30 arylene group, a substituted or unsubstituted C6-C30 aryloxy group, a substituted or unsubstituted C7-C30 arylalkylene group, a substituted or unsubstituted C2-C30 heteroarylene group, a substituted or unsubstituted C2-C30 heteroaryloxy group, a substituted or unsubstituted C3-C30 heteroarylalkylene group, a substituted or unsubstituted C4-C30 carbocyclic group, a substituted or unsubstituted C5-C30 carbocyclic alkylene group, a substituted or unsubstituted C2-C30 heterocyclic group, or a substituted or unsubstituted C3-C30 heterocyclic alkylene group,

R₆, R₇, R₈, R₉, R₁₀, and R₁₁ are each independently a hydrogen atom, a substituted or unsubstituted C1-C30 alkyl group, a substituted or unsubstituted C1-C30 alkoxy group, a substituted or unsubstituted C2-C30 alkenyl group, a substituted or unsubstituted C2-C30 alkynyl group, a substituted or unsubstituted C6-C30 aryl group, a substituted or unsubstituted C6-C30 aryloxy group, a substituted or unsubstituted C7-C30 arylalkyl group, a substituted or unsubstituted C2-C30 heteroaryl group, a substituted or unsubstituted C2-C30 heteroaryloxy group, a substituted or unsubstituted C3-C30 heteroarylalkyl group, a substituted or unsubstituted C4-C30 carbocyclic group, a substituted or unsubstituted C5-C30 carbocyclic alkyl group, a substituted or unsubstituted C2-C30 heterocyclic group, or a substituted or unsubstituted C2-C30 heterocyclic alkyl group, and

R₆ and R₇, and R₈ and R₉ may each independently be linked to each other to form a ring, the ring being a C6-C10 cycloalkyl group, a C3-C10 heteroaryl group, a fused C3-C10 heteroaryl group, a C3-C10 heterocyclic group, or a fused C3-C10 heterocyclic group.

The ion-conductive polymer may form copolymers in diverse forms by further including the third repeating unit, the fourth repeating unit or a combination thereof, in addition to the first repeating unit or the second repeating unit. For example, the ion-conductive polymer may be an alternating copolymer, a block copolymer, or a random copolymer, each including: a first repeating unit or a second repeating unit; and the third repeating unit, the fourth repeating unit or a combination thereof.

For example, the ion-conductive polymer may further include a fifth repeating unit represented by Formula 9, a sixth repeating unit represented by Formula 10, a seventh repeating unit represented by Formula 11, or a combination thereof.

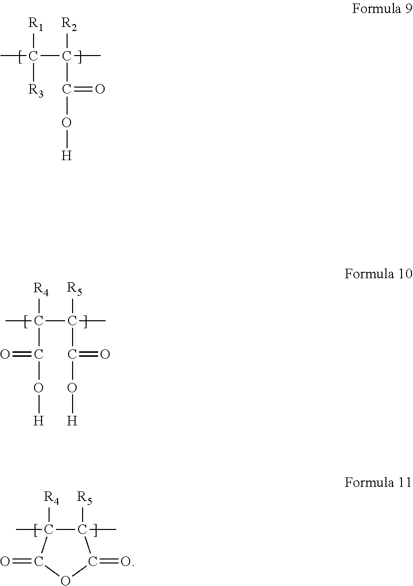

In Formulae 9, 10, and 11,

R₁, R₂, R₃, R₄, and R₅ are each independently a hydrogen atom, a substituted or unsubstituted C1-C30 alkyl group, a substituted or unsubstituted C1-C30 alkoxy group, a substituted or unsubstituted C2-C30 alkenyl group, a substituted or unsubstituted C2-C30 alkynyl group, a substituted or unsubstituted C6-C30 aryl group, a substituted or unsubstituted C6-C30 aryloxy group, a substituted or unsubstituted C7-C30 arylalkyl group, a substituted or unsubstituted C2-C30 heteroaryl group, a substituted or unsubstituted C2-C30 heteroaryloxy group, a substituted or unsubstituted C3-C30 heteroarylalkyl group, a substituted or unsubstituted C4-C30 carbocyclic group, a substituted or unsubstituted C5-C30 carbocyclic alkyl group, a substituted or unsubstituted C2-C30 heterocyclic group, or a substituted or unsubstituted C2-C30 heterocyclic alkyl group.

By further including a fifth repeating unit, a sixth repeating unit, a seventh repeating unit or a combination thereof in addition to the first repeating unit or the second repeating unit, the ion-conductive polymer may form polymers in diverse forms. For example, the ion-conductive polymer may form copolymers in diverse forms by further including a fifth repeating unit, a sixth repeating unit, a seventh repeating unit or a combination thereof, in addition to the first repeating unit or the second repeating unit; and a third repeating unit, a fourth repeating unit or a combination thereof. These copolymers may be, for example, alternating copolymers, block copolymers, or random copolymers.

For example, the ion-conductive polymer may be a polymer including a first repeating unit represented by Formula 6 or a third repeating unit represented by Formula 7:

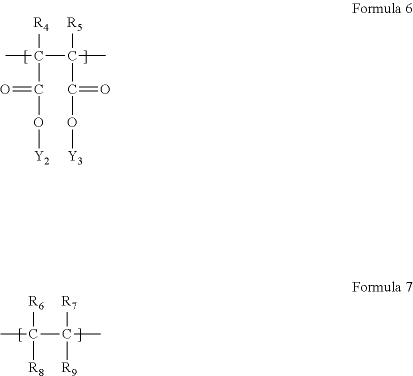

In Formulae 6, and 7,

R₄, R₅, R₆, R₇, R₈, and R₉ are each independently a hydrogen atom, a substituted or unsubstituted C1-C30 alkyl group, a substituted or unsubstituted C1-C30 alkoxy group, a substituted or unsubstituted C2-C30 alkenyl group, a substituted or unsubstituted C2-C30 alkynyl group, a substituted or unsubstituted C6-C30 aryl group, a substituted or unsubstituted C6-C30 aryloxy group, a substituted or unsubstituted C7-C30 arylalkyl group, a substituted or unsubstituted C2-C30 heteroaryl group, a substituted or unsubstituted C2-C30 heteroaryloxy group, a substituted or unsubstituted C3-C30 heteroarylalkyl group, a substituted or unsubstituted C4-C30 carbocyclic group, a substituted or unsubstituted C5-C30 carbocyclic alkyl group, a substituted or unsubstituted C2-C30 heterocyclic group, or a substituted or unsubstituted C2-C30 heterocyclic alkyl group,

R₆ and R₇, and R₈ and R₉ may each independently be linked to each other to form a ring, the ring being a C6-C10 cycloalkyl group, a C3-C10 heteroaryl group, a fused C3-C10 heteroaryl group, a C3-C10 heterocyclic group, or a fused C3-C10 heterocyclic group, and

Y₂ and Y₃ are each independently a hydrogen atom, an alkali metal, or an ammonium group,

with the proviso that at least one of Y₂ and Y₃ is lithium.

In the polymer including the first repeating unit represented by Formula 6 and the third repeating unit represented by Formula 7, the sum of mole fractions of the first repeating unit represented by Formula 6 and the third repeating unit represented by Formula 7 is equal to 1. A mole fraction of each of the first repeating unit represented by Formula 6 and the third repeating unit represented by Formula 7 may be, for example, 0.01 to 0.99. A polymerization degree of the polymer may be, for example, about 100 to about 50,000.

The polymer including the first repeating unit represented by Formula 6 and the third repeating unit represented by Formula 7 may be, for example, an alternating copolymer, a block copolymer, or a random copolymer.

The polymer including the first repeating unit represented by Formula 6 and the third repeating unit represented by Formula 7 may provide a lithium ion pathway by including a lithium-containing functional group represented by —(C═O)—OLi.

For example, the ion-conductive polymer may be a polymer including a first repeating unit represented by Formula 6 and a third repeating unit represented by Formula 7, and a sixth repeating unit represented by Formula 10 or a seventh repeating unit represented by Formula 11:

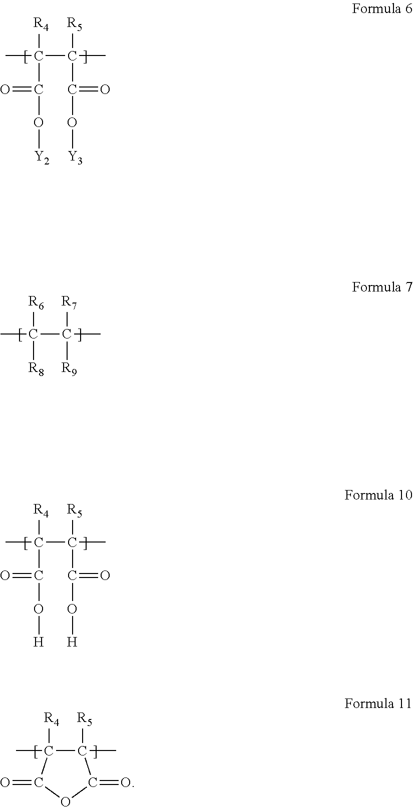

In Formulae 6, 7, 10, and 11,

R₄, R₅, R₆, R₇, R₈, and R₉ are each independently a hydrogen atom, a substituted or unsubstituted C1-C30 alkyl group, a substituted or unsubstituted C1-C30 alkoxy group, a substituted or unsubstituted C2-C30 alkenyl group, a substituted or unsubstituted C2-C30 alkynyl group, a substituted or unsubstituted C6-C30 aryl group, a substituted or unsubstituted C6-C30 aryloxy group, a substituted or unsubstituted C7-C30 arylalkyl group, a substituted or unsubstituted C2-C30 heteroaryl group, a substituted or unsubstituted C2-C30 heteroaryloxy group, a substituted or unsubstituted C3-C30 heteroarylalkyl group, a substituted or unsubstituted C4-C30 carbocyclic group, a substituted or unsubstituted C5-C30 carbocyclic alkyl group, a substituted or unsubstituted C2-C30 heterocyclic group, or a substituted or unsubstituted C2-C30 heterocyclic alkyl group, and

Y₂ and Y₃ are each independently a hydrogen atom, an alkali metal, or an ammonium group,

with the proviso that at least one of Y₂ and Y₃ is lithium.

In the polymer including the first repeating unit represented by Formula 6 and the third repeating unit represented by Formula 7, and the sixth repeating unit represented by Formula 10 or the seventh repeating unit represented by Formula 11, the sum of mole fractions of the first repeating unit represented by Formula 6 and the third repeating unit represented by Formula 7, and the sixth repeating unit represented by Formula 10 or the seventh repeating unit represented by Formula 11 is equal to 1. A mole fraction of each of the first repeating unit represented by Formula 6 and the third repeating unit represented by Formula 7, and the sixth repeating unit represented by Formula 10 or the seventh repeating unit represented by Formula 11 may be, for example, 0.01 to 0.99. A polymerization degree of the polymer may be, for example, about 100 to about 50,000.

The polymer including the first repeating unit represented by Formula 6 and the third repeating unit represented by Formula 7, and the sixth repeating unit represented by Formula 10 or the seventh repeating unit represented by Formula 11 may be, for example, an alternating copolymer, a block copolymer, or a random copolymer.

The polymer including the first repeating unit represented by Formula 6 and the third repeating unit represented by Formula 7, and the sixth repeating unit represented by Formula 10 or the seventh repeating unit represented by Formula 11 may provide a lithium ion pathway by including a lithium-containing functional group represented by —(C═O)—OLi.

For example, the third repeating unit represented by Formula 7 may be a repeating unit represented by Formula 7a, Formula 7b, or Formula 7c:

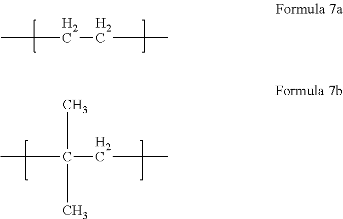

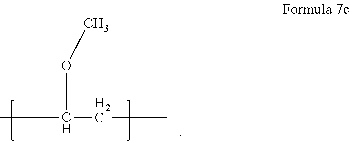

For example, the ion-conductive polymer may be a polymer including a first repeating unit represented by Formula 6 or a fourth repeating unit represented by Formula 8:

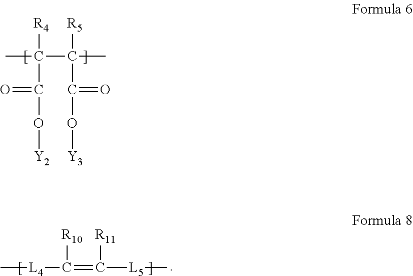

In Formulae 6 and 8,

L₄ and L₅ are each independently a single bond, or a substituted or unsubstituted C1-C30 alkylene group, a substituted or unsubstituted C2-C30 alkenylene group, a substituted or unsubstituted C2-C30 alkynylene group, a substituted or unsubstituted C6-C30 arylene group, a substituted or unsubstituted C6-C30 aryloxy group, a substituted or unsubstituted C7-C30 arylalkylene group, a substituted or unsubstituted C2-C30 heteroarylene group, a substituted or unsubstituted C2-C30 heteroaryloxy group, a substituted or unsubstituted C3-C30 heteroarylalkylene group, a substituted or unsubstituted C4-C30 carbocyclic group, a substituted or unsubstituted C5-C30 carbocyclic alkylene group, a substituted or unsubstituted C2-C30 heterocyclic group, or a substituted or unsubstituted C3-C30 heterocyclic alkylene group,

R₄, R₅, R₁₀, and R₁₁ are each independently a hydrogen atom, a substituted or unsubstituted C1-C30 alkyl group, a substituted or unsubstituted C1-C30 alkoxy group, a substituted or unsubstituted C2-C30 alkenyl group, a substituted or unsubstituted C2-C30 alkynyl group, a substituted or unsubstituted C6-C30 aryl group, a substituted or unsubstituted C6-C30 aryloxy group, a substituted or unsubstituted C7-C30 arylalkyl group, a substituted or unsubstituted C2-C30 heteroaryl group, a substituted or unsubstituted C2-C30 heteroaryloxy group, a substituted or unsubstituted C3-C30 heteroarylalkyl group, a substituted or unsubstituted C4-C30 carbocyclic group, a substituted or unsubstituted C5-C30 carbocyclic alkyl group, a substituted or unsubstituted C2-C30 heterocyclic group, or a substituted or unsubstituted C2-C30 heterocyclic alkyl group, and

Y₂ and Y₃ are each independently a hydrogen atom, an alkali metal, or an ammonium group,

with the proviso that at least one of Y₂ and Y₃ is lithium.

In the polymer including the first repeating unit represented by Formula 6 and fourth repeating unit represented by Formula 8, the sum of mole fractions of the first repeating unit represented by Formula 6 and the fourth repeating unit represented by Formula 7 is equal to 1. A mole fraction of each of the first repeating unit represented by Formula 6 and the fourth repeating unit represented by Formula 8 may be, for example, 0.01 to 0.99. A polymerization degree of the polymer may be, for example, about 100 to about 50,000.

The polymer including the first repeating unit represented by Formula 6 and the fourth repeating unit represented by Formula 8 may be, for example, an alternating copolymer, a block copolymer, or a random copolymer.

The polymer including the first repeating unit represented by Formula 6 and the fourth repeating unit represented by Formula 8 may provide a lithium ion pathway by including a lithium-containing functional group represented by —(C═O)—OLi.

For example, the fourth repeating unit represented by Formula 8 may be a repeating unit represented by Formula 8a:

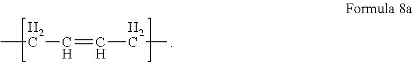

For example, the ion-conductive polymer may be a polymer including a first repeating unit represented by Formula 6 and a fourth repeating unit represented by Formula 8, and a sixth repeating unit represented by Formula 10 or a seventh repeating unit represented by Formula 11:

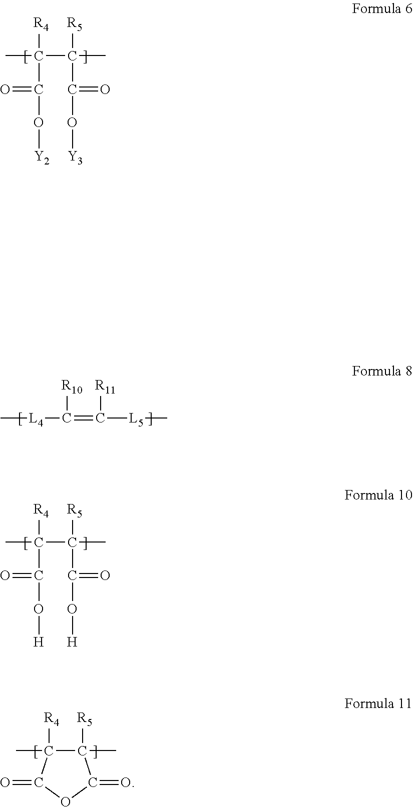

In Formulae 6, 8, 10, and 11,

L₄ and L₅ are each independently a single bond, or a substituted or unsubstituted C1-C30 alkylene group, a substituted or unsubstituted C2-C30 alkenylene group, a substituted or unsubstituted C2-C30 alkynylene group, a substituted or unsubstituted C6-C30 arylene group, a substituted or unsubstituted C6-C30 aryloxy group, a substituted or unsubstituted C7-C30 arylalkylene group, a substituted or unsubstituted C2-C30 heteroarylene group, a substituted or unsubstituted C2-C30 heteroaryloxy group, a substituted or unsubstituted C3-C30 heteroarylalkylene group, a substituted or unsubstituted C4-C30 carbocyclic group, a substituted or unsubstituted C5-C30 carbocyclic alkylene group, a substituted or unsubstituted C2-C30 heterocyclic group, or a substituted or unsubstituted C3-C30 heterocyclic alkylene group,

R₄, R₅, R₁₀, and R₁₁ are each independently a hydrogen atom, a substituted or unsubstituted C1-C30 alkyl group, a substituted or unsubstituted C1-C30 alkoxy group, a substituted or unsubstituted C2-C30 alkenyl group, a substituted or unsubstituted C2-C30 alkynyl group, a substituted or unsubstituted C6-C30 aryl group, a substituted or unsubstituted C6-C30 aryloxy group, a substituted or unsubstituted C7-C30 arylalkyl group, a substituted or unsubstituted C2-C30 heteroaryl group, a substituted or unsubstituted C2-C30 heteroaryloxy group, a substituted or unsubstituted C3-C30 heteroarylalkyl group, a substituted or unsubstituted C4-C30 carbocyclic group, a substituted or unsubstituted C5-C30 carbocyclic alkyl group, a substituted or unsubstituted C2-C30 heterocyclic group, or a substituted or unsubstituted C2-C30 heterocyclic alkyl group, and

Y₂ and Y₃ are each independently a hydrogen atom, an alkali metal, or an ammonium group,

with the proviso that at least one of Y₂ and Y₃ is lithium.

In the polymer including the first repeating unit represented by Formula 6 and the fourth repeating unit represented by Formula 8, and the sixth repeating unit represented by Formula 10 or the seventh repeating unit represented by Formula 11, the sum of mole fractions of the first repeating unit represented by Formula 6 and the fourth repeating unit represented by Formula 8, and the sixth repeating unit represented by Formula 10 or the seventh repeating unit represented by Formula 11 is equal to 1. A mole fraction of each of the first repeating unit represented by Formula 6 and the fourth repeating unit represented by Formula 8, and the sixth repeating unit represented by Formula 10 or the seventh repeating unit represented by Formula 11 may be, for example, 0.01 to 0.99. A polymerization degree of the polymer may be, for example, about 100 to about 50,000.

The polymer including the first repeating unit represented by Formula 6 and the fourth repeating unit represented by Formula 8, and the sixth repeating unit represented by Formula 10 or the seventh repeating unit represented by Formula 11 may be, for example, an alternating copolymer, a block copolymer, or a random copolymer.

The polymer including the first repeating unit represented by Formula 6 and the fourth repeating unit represented by Formula 8, and the sixth repeating unit represented by Formula 10 or the seventh repeating unit represented by Formula 11 may provide a lithium ion pathway by including a lithium-containing functional group represented by —(C═O)—OLi.

For example, the ion-conductive polymer may be a polymer including an eighth repeating unit represented by Formula 12:

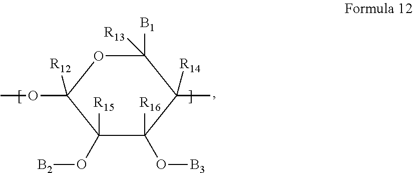

wherein, in Formula 12,

B₁ is -L6-A4-L7-X₄—Y₄ or -L6-A4-Y₄,

B₂ is a hydrogen atom or -L8-X₅—Y₅,

B₃ is a hydrogen atom or -L9-X₆—Y₆,

A4 is a single bond or —O—,

L6, L7, L8, and L9 are each independently a single bond, or a substituted or unsubstituted C1-C30 alkylene group, a substituted or unsubstituted C2-C30 alkenylene group, a substituted or unsubstituted C2-C30 alkynylene group, a substituted or unsubstituted C6-C30 arylene group, a substituted or unsubstituted C7-C30 arylalkylene group, a substituted or unsubstituted C2-C30 heteroarylene group, a substituted or unsubstituted C3-C30 heteroarylalkylene group, a substituted or unsubstituted C4-C30 carbocyclic group, a substituted or unsubstituted C5-C30 carbocyclic alkylene group, a substituted or unsubstituted C2-C30 heterocyclic group, or a substituted or unsubstituted C3-C30 heterocyclic alkylene group,

R₁₂, R₁₃, R₁₄, and R₁₅ are each independently a hydrogen atom, a substituted or unsubstituted C1-C30 alkyl group, a substituted or unsubstituted C1-C30 alkoxy group, a substituted or unsubstituted C2-C30 alkenyl group, a substituted or unsubstituted C2-C30 alkynyl group, a substituted or unsubstituted C6-C30 aryl group, a substituted or unsubstituted C6-C30 aryloxy group, a substituted or unsubstituted C7-C30 arylalkyl group, a substituted or unsubstituted C2-C30 heteroaryl group, a substituted or unsubstituted C2-C30 heteroaryloxy group, a substituted or unsubstituted C3-C30 heteroarylalkyl group, a substituted or unsubstituted C4-C30 carbocyclic group, a substituted or unsubstituted C5-C30 carbocyclic alkyl group, a substituted or unsubstituted C2-C30 heterocyclic group, or a substituted or unsubstituted C2-C30 heterocyclic alkyl group,

X4, X5, and X6 are each independently —C(═O)O—, —OS(═O)₂O—, —S(═O)₂O—, —S(═O)O—, —OP(═O)(OY)O—, or —P(═O)(OY)O—,

Y, Y4, Y5, and Y6 are each independently a hydrogen atom, an alkali metal, or an ammonium group,

with the proviso that at least one of Y4, Y5, and Y6 is lithium.

In Formula 12, for example, B₁ may be —C(═O)O—Y4, —CH₂—O—CH₂—C(═O)O—Y4, or —CH₂—O—Y4,

B₂ may be a hydrogen atom or —CH₂—C(═O)O—Y5,

B₃ may be a hydrogen atom or —CH₂—(C═O)O—Y6, and at least one of Y4, Y5, and Y6 may be lithium.

The polymer including the eighth repeating unit represented by Formula 12 may provide a lithium ion pathway by including a lithium-containing functional group represented by —(C═O)—OLi.

The ion-conductive polymer includes lithium polyacrylic acid, lithium polymethacrylic acid, lithium polymaleic acid, lithium poly(ethylene-alt-maleic acid), lithium poly(isobutylene-alt-maleic acid), lithium poly(butadiene-co-maleic acid), lithium poly(methylvinyl ether-alt-maleic acid), lithium poly(vinylether-alt-maleic acid), lithium poly(2-acrylamido-2-methyl-1-propanesulfonate), lithium polystyrene sulfonate, lithium carboxymethylcellulose, lithium alginate, lithium polysulfonate fluoropolymer, or a combination thereof. These polymers include a lithium substituent. For example, “lithium” of the lithium polyacrylic acid means “lithium substituted”. However, embodiments are not limited thereto, and any ion-conductive polymer including a lithium substituent available in the art may be used.

For example, the lithium polysulfonate fluoropolymer may be provided by neutralization of a polysulfonate fluoropolymer. The polysulfonate fluoropolymer may be prepared by neutralization with a base such as LiOH.

The polysulfonate fluoropolymer may include a fluoropolymer with a pendant group terminating with a sulfonic acid group.

The backbone and pendant chain included in the lithium polysulfonate fluoropolymer may be about 40% or greater, 60% or greater, or 80% or greater of the total weight of the chains. The backbone and pendant chain included in the lithium polysulfonate fluoropolymer may be perfluorated.

The polysulfonate fluoropolymer may be derived from a polysulfonate fluoropolymer including a highly fluorinated backbone and pendant group.

For example, the pendant chain included in the polysulfonate fluoropolymer may be represented by Structural Formula 1:

HO₃S—(CFR_{f})ₐ(CFR_{f})_{b}—Z1-(CFR_{f})_{c}(CFR_{f})_{d}-Z2- Structural Formula 1

wherein, in Structural Formula 1,

Z1 and Z2 are —O— or a single bond,

each R_{f} is independently F, a straight or branched fluoroalkyl group, a straight or branched fluoroalkoxy group, or a straight or branched fluoroether group, wherein the fluoroalkyl group, the fluoroalkoxy group, or the fluoroether group includes 1 to 15 carbon atoms and 0 to 4 hydrogen atoms in the chain thereof, and

a, b, c, and d are each independently 0 to 3, and c+d is 1 to 6.

The pendant group included in the lithium polysulfonate fluoropolymer may be, for example, —OCF₂CF(CF₃)OCF₂CF₂SO₃Li, —O(CF₂)₄SO₃Li, or a combination thereof.

For example, the lithium polysulfonate fluoropolymer may be represented by Formula 13:

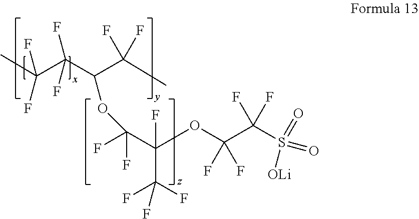

wherein, in Formula 13,
x+y+z=1, 0<x<1, 0<y<1, and 0<z<1, wherein x, y, and z each indicate a mole fraction of a repeating unit.

A molecular weight of the ion-conductive polymer may be, for example, 10,000 Daltons or greater, 30,000 Daltons or greater, 50,000 Daltons or greater, or 100,000 Daltons or greater.

The molecular weight of the ion-conductive polymer may be, for example, 3,000,000 Daltons or less, 2,000,000 Daltons or less, or 1,500,000 Dalton or less.

The molecular weight of the ion-conductive polymer may be, for example, about 100,000 Daltons to about 1,500,000 Daltons, about 300,000 Daltons to about 1,500,000 Daltons, about 500,000 Daltons to about 1,500,000 Daltons, or about 1,000,000 Daltons to about 1,500,000 Daltons.

The molecular weight of the ion-conductive polymer may be, for example, 10,000s Dalton to about 500,000 Daltons, about 10,000 Daltons to about 100,000 Daltons, about 10,000 Daltons to about 80,000 Daltons, or about 10,000 Daltons to about 50,000 Daltons.

The lithium polysulfonate fluoropolymer may be, for example, lithium-substituted Nafion™

The molecular weight of the ion-conductive polymer may be a viscosity average molecular weight. The viscosity average molecular weight of the ion-conductive polymer may be measured using a viscometer.

The anode interlayer may include an electron-conductive polymer as the second conductive binder. By including the electron-conductive binder in the anode interlayer, the internal resistance of the anode interlayer may be reduced, and an additional electron migration pathways may be provided in the anode interlayer.

The electron-conductive polymer may include, for example, π-conjugated backbone. The π-conjugated backbone may have a structure in which a single bond and a double bond are alternately linked. The π-conjugated backbone may include, for example, a sulfide group (—S—), an ether group (—O—), or the like, instead of a single bond. In the π-conjugated backbone, a double bond alternates with a single bond, a sulfide group, an ether group, or a combination thereof, and thus, through such a backbone, π-electrons may freely migrate. Accordingly, the π-conjugated backbone may be provided with electron conductivity. The π-conjugated backbone may be, for example, a chain including: an aliphatic chain including no heteroatom, an aliphatic chain including a heteroatom, an aromatic ring, a heteroaromatic ring, or a combination thereof. The aromatic ring or heteroaromatic ring may have a structure with at least two fused rings. The aliphatic chain including no heteroatom may be a polyenyl chain. The aliphatic chain including a heteroatom may be a polyethylene chain including a sulfide group (—S—), an ether group (—O—), or the like. The aromatic ring may be, for example, a benzene ring. The heteroaromatic ring may include, for example, a thiophene ring, an aniline ring, a pyrrole ring, a thianaphthene ring, a fluorine ring, an indole ring, an azepine ring, a carbazole ring, an azulene ring, a purine ring, a selenophen ring, a telluropen ring, or the like.

The electron-conductive polymer may include poly(3,4-ethylenedioxythiophene):poly(styrenesulfonate) (PEDOT:PSS), poly(3,4-ethylenedioxythiophene) (PEDOT), poly(phenylene sulfide) (PPS), poly(p-phenylene sulfide), polyaniline (PANI), polypyrrole (PPy), polyacetylene (PA), poly(p-phenylene), poly(phenylene vinylene) (PPV), poly(p-phenylene vinylene), poly(thienylene vinylene) (PTV), polyphenylene such as poly(p-phenylene), polythiophene (PT), poly(3-alkylthiphene) (P3ATs), poly(isothianaphthene) (ITN), polyfluorene, polyindole, polyazepine, polycarbazole, polyazulene, polyfuran, polyselenophenes, polytellurophene, a derivative thereof, or a combination thereof. However, embodiments are not limited thereto, and any electron-conductive polymer available in the art may be used.

Since the electron-conductive polymer is a water-soluble polymer or a water-dispersible polymer, a composition including the electron-conductive polymer may be easily prepared, and it may be simple to perform a process of manufacturing an anode and an all-solid secondary battery, and the electron-conductive polymer is also eco-friendly since no organic solvent needs to be used. For example, the water-soluble polymer or water-dispersible polymer which can be used as the electron-conductive polymer may include a π-conjugated backbone and an acidic functional group linked to the backbone. The acidic functional group linked to the π-conjugated backbone may provide the electron-conductive polymer water solubility or waster dispensability. For example, the acidic functional group linked to the π-conjugated backbone may be a functional group including a proton that can be substituted with lithium. The acidic functional group linked to the π-conjugated backbone may be, for example, —C(═O)OH, —OS(═O)₂OH, —S(═O)₂OH, —S(═O)OH, —OP(═O)(OH)₂, —P(═O)(OH)₂, or a combination thereof. At least a portion of the acidic functional group linked to the π-conjugated backbone may a lithium substituent. The acidic functional group linked to the r-conjugated backbone may include a lithium-containing functional group. The lithium-containing functional group included in the acidic functional group linked to the r-conjugated backbone may be, for example, —C(═O)OLi, —OS(═O)₂OLi, —S(═O)₂OLi, —S(═O)OLi, —OP(═O)(OH)OLi, —OP(═O)(OLi)₂, —P(═O)(OH)OLi, —P(═O)(OLi)₂, or a combination thereof. An amount of the lithium-containing functional group included in the electron-conductive polymer may be about 0 mol % to about 100 mol %, about 1 mol % to about 100 mol %, to about 10 mol % to about 100 mol %, to about 30 mol % to about 100 mol %, to about 50 mol % to about 100 mol %, to about 70 mol % to about 100 mol %, or about 90 mol % to about 100 mol % of the total mole number of the acidic functional group included in the electron-conductive polymer. The sum of the amounts of the first conductive binder and the second conductive binder may be, for example, about 1 part to about 20 parts by weight, about 5 parts to about 20 parts by weight, about 10 parts to about 20 parts by weight, or about 10 parts to about 15 parts by weight, with respect to 100 parts by weight of the material capable of undergoing lithiation and delithiation.

By including the sum of the first conductive binder and the second conductive binder being within these ranges, increase in the internal resistance of the anode interlayer may be further suppressed, and formation of lithium dendrite may be more effectively suppressed. An amount of the first conductive binder may be about 1 part to about 20 parts by weight, about 3 parts to about 15 parts by weight, about 3 parts to about 10 parts by weight, or about 5 parts to about 10 parts by weight, with respect to 100 parts by weight of the material capable of undergoing lithiation and delithiation. When the amount of the first conductive binder is too small, formation of an ion conduction pathway of the anode interlayer may not be smooth. An amount of the second conductive binder may be about 1 part to about 20 parts by weight, about 3 parts to about 15 parts by weight, about 3 parts to about 10 parts by weight, or about 5 parts to about 10 parts by weight, with respect to 100 parts by weight of the material capable of undergoing lithiation and delithiation. When the amount of the first conductive binder is too small, formation of an ion conduction pathway of the anode interlayer may not be smooth. A mixing weight ratio between the first conductive binder and the second conductive binder may be, for example, about 10:90 to about 90:10, about 20:80 to about 80:20, about 30:70 to about 70:30, or about 40:60 to about 60:40. By having the mixing weight ratio between the first conductive binder and the second conductive binder within these ranges, increases in the internal resistance of the anode interlayer may be further suppressed, and the formation of lithium dendrites may be more effectively suppressed. The carbon and the first metal included in the cathode interlayer may be in the form of particles.

For example, the carbon and the first metal in the form of particles may each independently have an average particle diameter of 4 micrometers (μm) or less, 3 μm or less, 2 μm or less, 1 μm or less, or 900 nanometers (nm) or less. For example, the carbon in the form of particles may have an average particle diameter of about 10 nm to about 4 μm, about 10 nm to about 3 μm, about 10 nm to about 2 μm, about 10 nm to about 1 μm, or about 10 nm to about 900 nm. For example, the first metal in the form of particles may have an average particle diameter of about 10 nm to about 1 μm, about 10 nm to about 900 nm, about 10 nm to about 500 nm, about 10 nm to about 300 nm, or about 10 nm to about 100 nm. By having the average particle diameters of the carbon and the first metal in the form of particles within these ranges, the carbon and the first metal may more easily undergo reversible lithiation and/or delithiation during charging and discharging. The average particle diameters of the carbon and the first metal may each be, for example, median diameters (D50) measured using a laser particle size distribution analyzer. The carbon may be, for example, amorphous carbon.

The amorphous carbon may be, for example, carbon black (CB), acetylene black (AB), furnace black (FB), ketjen black (KB), graphene, or the like, but embodiments are not limited thereto, and any materials classified as amorphous carbon in the art may be used. The amorphous carbon, as carbon without crystallinity or with very low crystallinity, is classified into crystalline carbon or graphite-based carbon. A nitrogen adsorption specific surface area of the amorphous carbon may be, for example, from about 1 square meters per gram (m²/g) to about 500 m²/g, from about 10 m²/g to about 450 m²/g, from about 25 m²/g to about 400 m²/g, or from 0.1 m²/g to about 300 m²/g.

Here, the term “nitrogen adsorption specific surface area” refers to, when the anode active material layer 22 includes a single type of amorphous carbon, the nitrogen adsorption specific surface area of that one type of amorphous carbon. In addition, when the anode active material layer 22 contains multiple types of amorphous carbons, the term “nitrogen adsorption specific surface area” refers to the nitrogen adsorption specific surface area of each of the multiple types of amorphous carbon. For example, the nitrogen adsorption specific surface area may be measured by a nitrogen adsorption method defined by JIS K6217-2:2001. In particular, amorphous carbon, for example, carbon black or the like, degassed once at a high temperature of about 300° C., is cooled down to the temperature of liquid nitrogen under a nitrogen atmosphere. Then, after reaching an equilibrium state, an increase in mass of the carbon sample (nitrogen adsorption amount) and the pressure of the nitrogen atmosphere at the equilibrium are measured and applied to the Brunauer-Emmett-Teller (BET) equation, to thereby calculate a value of nitrogen adsorption specific surface area. For example, the first metal may include silver (Ag), silicon (Si), germanium (Ge), tellurium (Te), gold (Au), platinum (Pt), palladium (Pd), silicon (Si), silver (Ag), aluminum (Al), bismuth (Bi), tin (Sn), zinc (Zn), an alloy thereof, or a combination thereof.

For example, nickel (Ni) does not undergo lithiation and delithiation, and thus is not the first metal. In other words, Ni does not form an alloy with lithium, and thus, is not the first metal. The first metal may be in the form of particles, and for example, may further include a conductive coating layer arranged on the surfaces of particles.

By the first metal particles further including the conductive coating layer on the surfaces thereof, electronic conductivity of the first metal particles may be further improved. The conductive coating layer may have a thickness of about 1 nm to about 10 nm. The conductive coating layer may be a carbon layer. For example, the surfaces of silicon (Si) particles may be coated with a carbon layer of about 1 nm to about 10 nm in order to improve electronic conductivity. The material capable of undergoing lithiation and delithiation may include first particles consisting of amorphous carbon, or a mixture of first particles consisting of amorphous carbon, and a first metal.

For example, the anode interlayer may include only the first particle consisting of amorphous carbon.

In other embodiments, the anode interlayer may include a mixture of a first particle consisting of amorphous carbon, and a first metal including silver (Ag), silicon (Si), germanium (Ge), tellurium (Te), gold (Au), platinum (Pt), palladium (Pd), silicon (Si), silver (Ag), aluminum (Al), bismuth (Bi), tin (Sn), zinc (Zn), an alloy thereof, or a combination thereof.

The amount of the second particles may be about 8 weight percent (wt %) to about 60 wt %, about 10 wt % to about 50 wt %, about 15 wt % to about 40 wt %, or about 20 wt % to about 30 wt %, with respect to a total weight of the mixture. As the amount of the second particles is within these ranges, for example, an all-solid secondary battery including the anode interlayer may have further improved cycle characteristics.

The anode interlayer may be for an all-solid secondary battery, and an all-solid secondary battery may include a cathode active material layer and the anode interlayer.

A ratio between the charge capacity of the cathode active material layer and the charge capacity of the anode interlayer, i.e., a capacity ratio, may satisfy the condition of Equation 1:

wherein 0.01<b/a<0.5, Equation 1

a is charge capacity of the cathode active material layer (mAh) and

b is charge capacity of the anode interlayer (mAh).

The capacity ratio may be, for example, 0.01<b/a≤0.45, 0.01<b/a≤0.4, 0.02≤b/a≤0.3, 0.03≤b/a≤0.25, 0.03≤b/a≤0.2, or 0.05≤b/a≤0.1.

The charge capacity of the cathode active material layer may be obtained by multiplying the charge specific capacity (milliampere hours per gram, mAh/g) of a cathode active material by the mass of the cathode active material in the cathode active material layer. When a plurality of cathode active materials are used, for each cathode active material, the value of the charge capacity density multiplied by the mass may be calculated, and the sum of these values may be referred to as the charge capacity of the cathode active material layer. The charge capacity of the anode active material layer is also calculated using the same method. The charge capacity of the anode active material layer may be obtained by multiplying the charge specific capacity (mAh/g) of an anode active material by the mass of the anode active material in the anode active material layer. When a plurality of anode active materials are used, for each anode active material, the value of the charge capacity density multiplied by the mass may be calculated, and the sum of these values may be referred to as the charge capacity of the anode active material layer. Here, the charge capacity densities of the cathode and anode active materials are capacities estimated using an all-solid half cell using lithium metal as a counter electrode. In practice, the charge capacities of the cathode active material layer and the anode active material layer are directly measured using an all-solid half-cell.

A specific method of directly measuring a charge capacity may be, for example, a method as described below. First, the charge capacity of the cathode active material layer is measured by manufacturing an all-solid half cell using the cathode active material layer as a working electrode and Li as a counter electrode and performing constant current-constant voltage (CC-CV) charging from OCV (open voltage) to the upper limit charge voltage. The upper limit charge voltage is defined by the standard of JIS C 8712: 2015, the content of which is incorporated herein by reference in its entirety, and refers to a voltage that is obtainable by applying 4.25V to a lithium cobalt oxide-based cathode and the provision of JIS C 8712: 2015 (A.3.2.3. Safety requirements for cases using other upper limit charge voltages) to other cathodes. The charge capacity of the anode active material layer is measured by manufacturing an all-solid half cell using the anode active material layer as a working electrode and Li as a counter electrode and performing constant current-constant voltage (CC-CV) charging from OCV (open voltage) to 0.01V.

For example, the test cells described above may be manufactured using a method as below. The cathode active material layer or the first anode active material layer for measuring the charge capacity is perforated in a disc form having a diameter of 14 millimeters (mm). 200 milligrams (mg) of solid electrolyte powder that is the same as used in the all-solid secondary battery is solidified at 40 megaPascals (MPa) to form a pellet having a diameter of 14 mm and a thickness of about 1 mm. The pellet is inserted into a tube having an inner diameter of 14 mm, the cathode active material layer or the first anode active material layer perforated into a disc form is inserted through one end of the tube, and a lithium foil having a diameter of 14 mm and a thickness of 0.03 mm is inserted through the other end of the tube. In addition, one stainless steel disc is inserted into each of the two sides of the tube, and the entire tube is pressed with 300 MPa in the axial direction of the tube to integrate the contents. The integrated contents are removed from the tube, sealed in a case under a constant pressure of 22 MPa, and used as a test cell. The charge capacity of the cathode active material layer may be measured, for example, by performing constant-current charging on the test cell manufactured as above, with a current density of 0.1 mA and then constant-voltage charging to 0.02 mA.

The capacity ratio from Equation 1 is greater than 0.01 and less than 0.5. By having a capacity ratio in this range, the anode interlayer may have improved structural stability and may provide increased battery capacity.

When the capacity ratio is too low, the anode interlayer may have lower structural stability. For example, when the thickness of the anode interlayer is very small, the capacity ratio may be too low. In this case, it is likely that the anode interlayer collapses due to repeated charging and discharging, thus causing deposition and growth of lithium dendrites. Accordingly, characteristics of the all-solid secondary battery may be deteriorated. In addition, when the capacity ratio is too high, the amount of deposition of lithium in the anode may be reduced, and battery capacity may be reduced.

The anode interlayer may have a thickness of, for example, about 1 μm to about 20 μm, about 1 μm to about 15 μm, or about 1 μm to about 10 μm. Due to the anode interlayer having a thickness within these ranges, the anode interlayer may have improved structural stability, and the all-solid secondary battery may have improved cycle characteristics. The thickness of the anode interlayer may be measured by, for example, observation of a cross-section of the all-solid secondary battery with a scanning electron microscope (SEM).

### All-Solid Secondary Battery

According to one or more embodiments, an all-solid secondary battery includes: a cathode layer including a cathode active material layer; an anode layer; and a solid electrolyte layer arranged between the cathode layer and the anode layer and including a solid electrolyte, wherein the anode layer includes an anode current collector, and a first anode interlayer arranged between the solid electrolyte layer and the anode current collector, and the first anode interlayer includes the anode interlayer according to any of the embodiments described above. Since the all-solid secondary battery includes the first anode interlayer, increases in internal resistance may be suppressed, and the growth of lithium dendrites may be suppressed. Accordingly, the all-solid secondary battery may have improved cycle characteristics. In addition, the utilization rate of the active material included in the all-solid secondary battery can be improved, and thus, the all-solid secondary battery may have improved energy density.

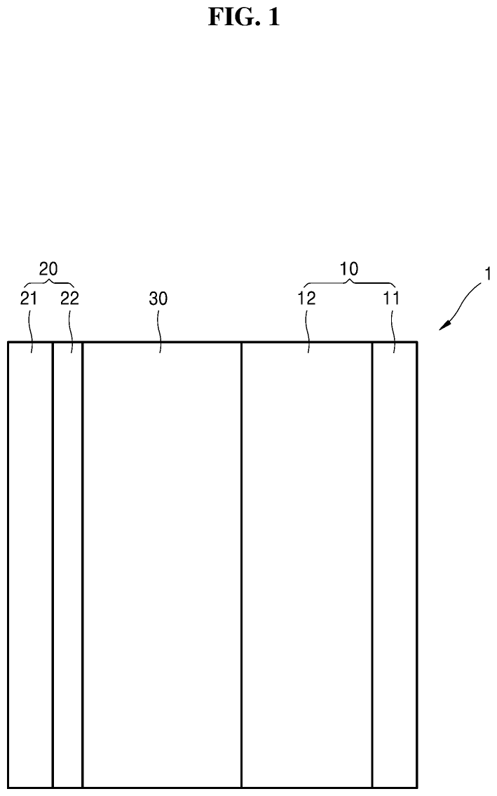

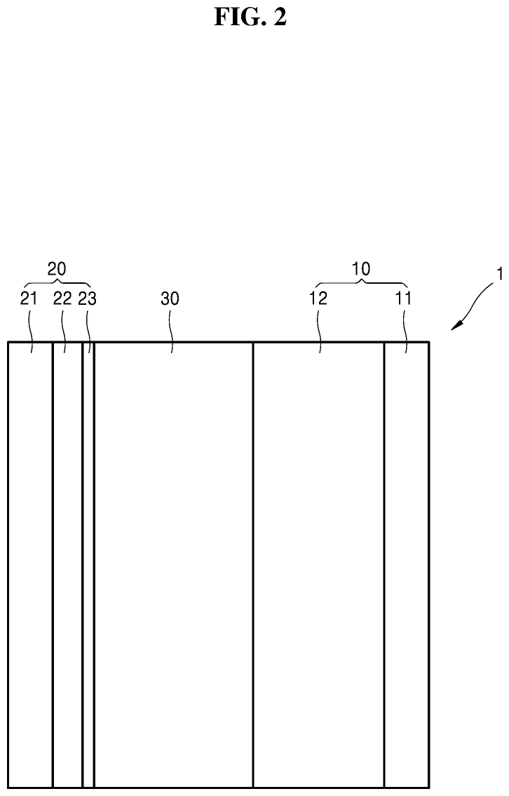

Referring to FIGS. 1 to 4, an all-solid secondary batter 1 includes: a cathode layer 10 including a cathode active material layer 12; an anode layer 20; and a solid electrolyte layer 30 arranged between the cathode layer 10 and the anode layer 20 and including a solid electrolyte.

### Anode Layer

The anode layer 20 includes an anode current collector 21, and a first anode interlayer 22 stacked on the anode current collector 21.

### Anode Current Collector

The anode current collector 21 may consist of a material which does not react with lithium, i.e., which does not an alloy or compound with lithium. The material constituting the anode current collector 21 may be, for example, copper (Cu), stainless steel, titanium (Ti), iron (Fe), cobalt (Co), nickel (Ni), or the like. The anode current collector 21 may consist of one material selected from these metals, or an alloy or clad of at least two of these metals. The anode current collector 21 may have, for example, a plate form or a foil form.

### First Anode Interlayer

The anode layer 20 includes the first anode interlayer 22 between the solid electrolyte layer 30 and the anode current collector 21. The first anode interlayer 22 includes the anode interlayer according to any of the embodiments described above. For details of the first anode interlayer 22, the descriptions of the anode interlayer provided above may be referred to.

### Second Anode Interlayer

The anode layer 20 may further include a second anode interlayer 23 between the solid electrolyte layer 30 and the first anode interlayer 22.

Due to the anode layer 20 additionally including the second anode interlayer 23, uniformity of current density and uniformity of lithium ion migration at the interface between the solid electrolyte layer 30 and the anode layer may be additionally improved.

Due to the anode layer 20 additionally including the second anode interlayer 23, increases in internal resistance of the all-solid secondary battery 1 and/or the growth of lithium dendrite may be more effectively suppressed.

The second anode interlayer 23 may contact the solid electrolyte layer 30. The second anode interlayer 23 may directly contact the solid electrolyte layer 30 and coat the solid electrolyte layer 30. The second anode interlayer 23 directly contacts the solid electrolyte layer 30, and thus may effectively coat defects, irregularities, grain boundaries, and the like exposed on the surface of the solid electrolyte layer. Accordingly, increases in interfacial resistance and/or the growth of lithium dendrites, between the solid electrolyte layer 30 and the anode layer 20, may be effectively suppressed.

The second anode interlayer 23 may further increase binding strength between the anode layer 20 and the solid electrolyte layer 30. Accordingly, the local formation and growth of lithium dendrites caused by a reduction in the binding strength between the anode layer 20 and the solid electrolyte layer 30 during charging and discharging processes of the all-solid secondary battery may be effectively suppressed. As a result, the all-solid secondary battery 10 may have improved structure stability and improved cycle characteristics.

The second anode interlayer 23 may include a second metal, an alloy of the second metal with lithium, or a combination thereof.

The second anode interlayer 23 may be, for example, a thin-film layer including a second metal. The second anode interlayer 23 may be, for example, a metal layer including at least one of a second metal or an alloy of a second metal with lithium. The second anode interlayer 23 may be a metal layer consisting of a second metal, lithium, and/or an alloy thereof. For example, the second anode interlayer 23 may be a metal layer consisting of a thin film of a second metal, a metal layer including an alloy phase of the second metal with lithium, or a metal layer including a second metal phase, a lithium metal phase, and an alloy phase of the second metal and lithium. The second anode interlayer 23 includes only a second metal at the time of battery assembly, but may additionally include an alloy of the second metal with lithium while charging and discharging proceed. The second anode interlayer 23 may not include, for example, a carbonaceous material and/or an organic material. The second anode interlayer 23 may not include a carbonaceous material, for example, crystalline carbon such as graphite, amorphous carbon such as carbon black, and carbon nanostructures such as carbon nanofibers. Since the second anode interlayer 23 is a metal layer, side reactions of carbonaceous material and/or organic material during charging and discharging process may be suppressed.

The second metal may include silver (Ag), silicon (Si), germanium (Ge), tellurium (Te), gold (Au), platinum (Pt), palladium (Pd), aluminum (Al), bismuth (Bi), tin (Sn), zinc (Zn), indium (In), gallium (Ga), titanium (Ti), zirconium (Zr), niobium (Nb), antimony (Sb), nickel (Ni), iron (Fe), cobalt (Co), chromium (Cr), magnesium (Mg), cesium (Ce), lanthanum (La), a combination thereof, or an alloy thereof. The second metal may be, for example, silver (Ag), silicon (Si), a germanium-tellurium (Ge—Te) alloy, or the like.

A thickness of the second anode interlayer 23 may be, for example, about 10% or less, about 8% or less, about 6% or less, about 5% or less, or about 3% or less of the thickness of the cathode active material layer 12.

The thickness of the second anode interlayer 23 may be, for example, about 0.01% to about 10%, about 0.01% to about 8%, about 0.01% to about 6%, about 0.01% to about 5%, or about 0.01% to about 3% of the thickness of the cathode active material layer 12.

Due to the second anode interlayer 23 having a thickness being less than that of the cathode active material layer 12, increases in interfacial resistance between the solid electrolyte layer 30 and the anode layer 20 may be suppressed.

The thickness of the second anode interlayer 23 may be, for example, about 10 nm to about 500 nm, about 10 nm to about 450 nm, about 10 nm to about 400 nm, about 10 nm to about 300 nm, about 20 nm to about 300 nm, about 20 nm to about 250 nm, about 20 nm to about 200 nm, or about 30 nm to about 200 nm. When the second anode interlayer 23 has a thickness within these ranges, increases in the internal resistance of the all-solid secondary battery 1 may be suppressed, and cycle characteristics may be improved. The second anode interlayer may be formed using a dry method or a wet method. The second anode interlayer may be formed using, for example, vacuum deposition, sputtering, or plating. However, embodiments are not limited to these methods. Any suitable method which can be used in the art to form the second anode interlayer 23 may be used.

When the thickness of the second anode interlayer 23 is two small, an effect of the introduction of the second anode interlayer 23 may be insignificant. When the thickness of the second anode interlayer 23 is too large, the all-solid secondary battery may have reduced energy density. The second anode interlayer 23 may be disposed using, for example, vacuum deposition, sputtering, or plating. However, embodiments are not limited to these methods. Any suitable method which can be used in the art to form an anode active material layer may be used.

A lithium precipitation layer may be absent between the second anode interlayer 23 and the solid electrolyte layer 30. Due to strong binding between the second anode interlayer 23 and the solid electrolyte layer 30, the formation and/or growth of lithium dendrite due to the formation of the lithium precipitation layer between the second anode interlayer 23 and the solid electrolyte layer 30 may be prevented. Accordingly, the all-solid secondary battery 1 may be prevented from deterioration.

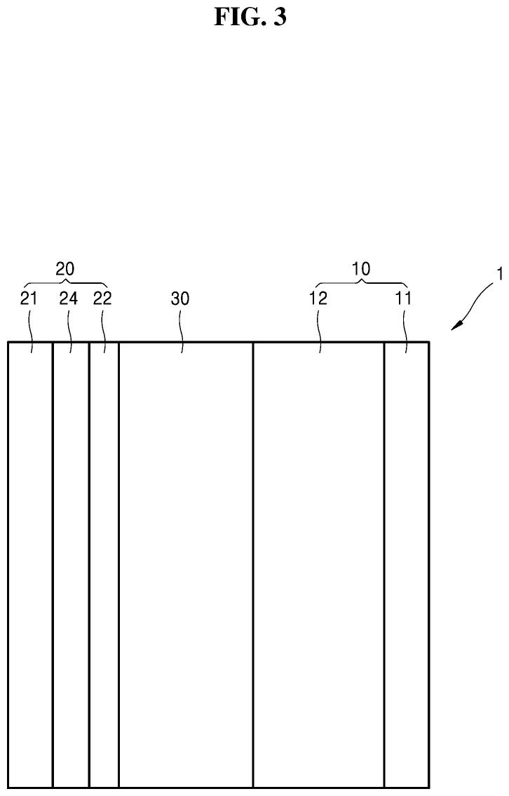

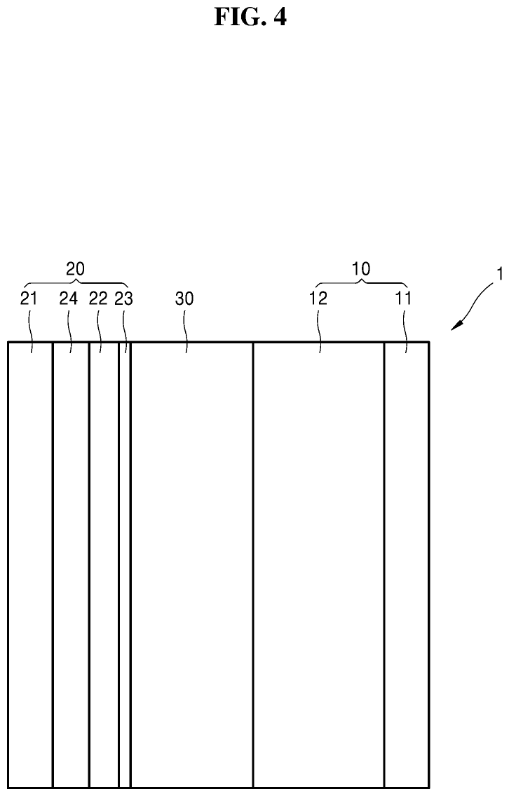

FIG. 3 is a schematic cross-sectional view of an all-solid secondary battery 1 according to another embodiment in which a metal layer is additionally introduced. FIG. 4 is a schematic cross-sectional view of an all-solid secondary battery 1 according to another embodiment in which a metal layer is additionally introduced.

Referring to FIGS. 3 and 4, the all-solid secondary battery 1 may further include a metal layer 24 between the first anode interlayer 22 and the anode current collector 21, before being charged. For example, the metal layer 24 may be a metal layer including lithium or a lithium alloy. Since the metal layer 24 is a metal layer including lithium or a lithium alloy, the metal layer 24 may function as a lithium reservoir. The lithium alloy may be, for example, a Li—Al alloy, a Li—Sn alloy, a Li—In alloy, a Li—Ag alloy, a Li—Au alloy, a Li—Zn alloy, a Li—Ge alloy, or a Li—Si alloy. However, embodiments are not limited to these alloys, and any suitable lithium alloy used in the art may be used. The metal layer 24 may consist of one of these alloys or lithium, or may consist of various alloys. The metal layer 24 may be a lithium foil, or a lithium alloy foil. The thickness of the metal layer 24 is not specifically limited, but may be, for example, about 1 μm to about 100 μm, about 1 μm to about 50 μm, about 1 μm to about 40 μm, about 1 μm to about 30 μm, or about 1 μm to about 20 μm. When the thickness of the metal layer 24 is too small, the metal layer 24 may not serve as a lithium reservoir. When the thickness of the metal layer 24 is too large, due to an increase in resistance of the metal layer 22, cycle characteristics of the all-solid secondary battery 1 may be deteriorated.

In other embodiments, by being charged, the all-solid secondary battery 1 may further include the metal layer 24 between the first anode interlayer 22 and the anode current collector 21. The metal layer 24 may be, for example, a plated lithium layer. The plated lithium layer is a metal layer including lithium or a lithium alloy. The thickness of the plated lithium layer is not specifically limited, but may be, for example, about 1 μm to about 100 μm, about 1 μm to about 50 μm, about 1 μm to about 40 μm, about 1 μm to about 30 μm, or about 1 μm to about 20 μm. When the thickness of the plated lithium layer is too small, the lithium precipitation layer may not serve as a lithium reservoir. When the thickness of the plated lithium layer is too large, due to an increase in resistance of the lithium precipitation layer, cycle characteristics of the all-solid secondary battery 1 may be deteriorated.

The all-solid secondary battery 1 may be configured so that a ratio between the charge capacity of the cathode active material layer 12 and the charge capacity of the first anode interlayer 22, i.e., a capacity ratio, satisfies the condition of Equation 1:

0.01<b/a<0.5, Equation 1

in which a is a charge capacity of the cathode active material layer (mAh), and

b is a charge capacity of the anode interlayer (mAh).

The capacity ratio may be, for example, 0.01<b/a≤0.45, 0.01<b/a≤0.4, 0.02≤b/a≤0.3, 0.03≤b/a≤0.25, 0.03≤b/a≤0.2, or 0.05≤b/a≤0.1.

For details of the capacity ratio, the descriptions provided above in connection with the anode interlayer may be referred to.

### Solid Electrolyte Layer

Referring to FIGS. 1 to 4, the solid electrolyte layer 30 includes a solid electrolyte disposed between the cathode layer 10 and the anode layer 20.

The solid electrolyte may be, for example, an oxide-based solid electrolyte. The oxide-based solid electrolyte may be at least one of Li_{1+x+y}AlₓTi₂₋ₓSi_{y}P_{3-y}O₁₂ (wherein 0<x<2 and 0≤y<3), BaTiO₃, Pb(ZrₓTi₁₋ₓ)O₃ (PZT, 0≤x≤1), Pb₁₋ₓLaₓZr_{1-y} Ti_{y}O₃ (PLZT) (wherein 0≤x<1 and 0≤y<1), Pb(Mg_{1/3}Nb_{2/3})O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, Li₃PO₄, LiₓTi_{y}(PO₄)₃ (wherein 0<x<2 and 0<y<3), LiₓAl_{y}Ti_{z}(PO₄)₃ (wherein 0<x<2, 0<y<1, and 0<z<3), Li_{1+x+y}(AlₐGa₁₋ₐ)ₓ(Ti_{b}Ge_{1-b})₂₋ₓSi_{y}P_{3-y}O₁₂ (wherein 0≤x≤1, 0≤y≤1, 0≤a≤1, 0≤b≤1), LiₓLa_{y}TiO₃ (wherein 0<x<2 and 0<y<3), Li₂O, LiOH, Li₂CO₃, LiAlO₂, Li₂O—Al₂O₃—SiO₂—P₂O₅—TiO₂—GeO₂, or Li₃₊ₓLa₃M₂O₁₂ (wherein M is Te, Nb, or Zr, and x is an integer from 1 to 10). The solid electrolyte may be prepared using, for example, sintering. For example, the oxide-based solid electrolyte may be a Garnet-type solid electrolyte of at least one of Li₇La₃Zr₂O₁₂ (LLZO) or Li₃₊ₓLa₃Zr₂₋ₐMₐO₁₂ (M-doped LLZO, wherein M is Ga, W, Nb, Ta, or Al, and 1≤x≤10, 0≤a≤2).

In another embodiment, the solid electrolyte may be, for example, a sulfide-based solid electrolyte. The sulfide-based solid electrolyte is, for example, at least one of Li₂S—P₂S₅, Li₂S—P₂S₅—LiX (wherein X is a halogen element), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (wherein m and n each are a positive number of 1 to 10), and Z is one of Ge, Zn, and Ga), Li₂S—GeS₂, Li₂S—SiS₂—Li₃PO₄, Li₂S—SiS₂—LiₚMO_{q} (wherein p and q each are a positive number of 1 to 10, M is one of P, Si, Ge, B, Al, Ga, and In), Li₇₋ₓPS₆₋ₓClₓ (wherein 0≤x≤2), Li₇₋ₓPS₆₋ₓBrₓ (wherein 0≤x≤2), or Li₇₋ₓPS₆₋ₓIₓ, (wherein 0≤x≤2). For example, the sulfide-based solid electrolyte may be prepared by treatment of a starting material such as Li₂S, P₂S₅, or the like using melt quenching or mechanical milling. After these treatments, thermal treatment may be performed. The sulfide-based solid electrolyte may be amorphous, crystalline, or a mixed state thereof.

In addition, the sulfide-based solid electrolyte may be, for example, any of the above-listed sulfide-based solid electrolyte materials including at least sulfur (S), phosphorous (P), and lithium (Li) as constituent elements. For example, the sulfide-based solid electrolyte may be a material including Li₂S—P₂S₅. When a sulfide-based solid electrolyte material including Li₂S—P₂S₅ is used, a mixed mole ratio of Li₂S to P₂S₅ (Li₂S:P₂S₅) may be, for example, in a range of about 50:50 to about 90:10.

The sulfide-based solid electrolyte may be a compound with argyrodite crystal structure. The compound with argyrodite-type crystal structure may include, for example, at least one of Li₇₋ₓPS₆₋ₓClₓ (wherein 0≤x≤2), Li₇₋ₓPS₆₋ₓBrₓ (wherein 0≤x≤2), or Li₇₋ₓPS₆₋ₓIₓ (wherein 0≤x≤2). In particular, the sulfide-based solid electrolyte included in a solid electrolyte may be an argyrodite-type compound including at least one of Li₆PS₅Cl, Li₆PS₅Br, or Li₆PS₅I.

For example, the solid electrolyte layer 30 may further include a binder. The binder included in the solid electrolyte layer 30 may be, for example, a styrene-butadiene rubber (SBR), polytetrafluoroethylene (PTFE), polyvinylidene fluoride (PVDF), polyethylene, polyacrylate, nitrile butadiene rubber (NBR), hydrogenated nitrile butadiene rubber (H-NBR), or the like. However, embodiments are not limited thereto. Any suitable binder available in the art may be used. The binder of the solid electrolyte layer 30 may be the same as or different from the binders of the cathode active material layer 12 and the first anode active material layer 22.

### Cathode Layer

The cathode layer 10 may include a cathode current collector 11 and a cathode active material layer 12.

### Cathode Current Collector

The cathode current collector 11 may be a plate or a foil that consists of indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof. The cathode current collector 11 may be omitted.

### Cathode Active Material Layer

The cathode layer 10 may include, for example, a cathode active material layer 12. The cathode active material layer 12 includes a cathode active material. The cathode active material is a material capable of undergoing lithiation and delithiation. The cathode active material may be, for example, a lithium transition metal oxide, such as lithium cobalt oxide (LCO), lithium nickel oxide, lithium nickel cobalt oxide, lithium nickel cobalt aluminum oxide (NCA), lithium nickel cobalt manganese oxide (NCM), lithium manganate, or lithium iron phosphate; nickel sulfide; copper sulfide; lithium sulfide; iron oxide; or vanadium oxide. However, embodiments are not limited thereto. Any suitable cathode active material available in the art may be used. These cathode active materials may be used alone or in a combination of at least two thereof.

The lithium transition metal oxide may be, for example, a compound represented by one of the following formulae: LiₐA_{1-b}B′_{b}D₂ (wherein 0.90≤a≤1 and 0≤b≤0.5); LiₐE_{1-b} B′_{b}O_{2-c}D_{c} (wherein 0.90≤a≤1, 0≤b≤0.5, and 0≤c≤0.05); LiE_{2-b}B′_{b}O_{5-c}D_{c} (wherein 0≤b≤0.5, and 0≤c≤0.05); LiₐNi_{1-b-c}Co_{b}B′_{c}D_{α} (wherein 0.90≤a≤1, 0≤b≤0.5, 0≤c≤0.05, and 0<α≤2); LiₐNi_{1-b-c}Co_{b}B′_{c}O_{2-α}F′_{α} (wherein 0.90≤a≤1, 0≤b<0.5, 0≤c≤0.05, and 0<α<2); LiₐNi_{1-b-c}Co_{b}B′_{c}O_{2-α}F′₂ (wherein 0.90≤a≤1, 0≤b≤0.5, 0≤s≤0.05, and 0<α<2); LiₐNi_{1-b-c}Mn_{b}B′_{c}D_{α} (wherein 0.90≤a≤1, 0≤b≤0.5, 0≤c≤0.05, and 0<α≤2); LiₐNi_{1-b-c}Mn_{b}B′_{c}O_{2-α}F_{α} (wherein 0.90≤a≤1, 0≤b≤0.5, 0≤c≤0.05, and 0<α<2); LiₐNi_{1-b-c}Mn_{b}B′_{c}O_{2-α}F′₂ (wherein 0.90≤a≤1, 0<b<0.5, 0≤c≤0.05, and 0<α<2); LiₐNi_{b}E_{c}G_{d}O₂ (wherein 0.90≤α<1, 0≤b≤0.9, 0<c<0.5, and 0.001≤d≤0.1); LiₐNi_{b}Co_{c}Mn_{d}GeₑO₂ (wherein 0.90≤a≤1, 0≤b≤0.9, 0≤c≤0.5, 0≤d≤0.5, and 0.001≤e≤0.1); LiₐNiG_{b}O₂ (wherein 0.90≤α<1, and 0.001≤b≤0.1); LiₐCoG_{b}O₂ (wherein 0.90≤a≤1 and 0.001≤b<0.1); LiₐMnG_{b}O₂ (wherein 0.90≤a≤1 and 0.001≤b≤0.1); LiₐMn₂G_{b}O₄ (wherein 0.90≤a≤1 and 0.001≤b≤0.1); QO₂; QS₂; LiQS₂; V₂O₅; LiV₂O₅; LiI′O₂; LiNiVO₄; Li_{(3-f)}J₂(PO₄)₃ (wherein 0≤f≤2); Li_{(3-f)}Fe₂ (PO₄)₃ (wherein 0≤f≤2); and LiFePO₄. In the formulae above, A may be nickel (Ni), cobalt (Co), manganese (Mn), or a combination thereof; B′ may be aluminum (Al), nickel (Ni), cobalt (Co), manganese (Mn), chromium (Cr), iron (Fe), magnesium (Mg), strontium (Sr), vanadium (V), a rare earth element, or a combination thereof; D may be oxygen (O), fluorine (F), sulfur (S), phosphorus (P), or a combination thereof; E may be cobalt (Co), manganese (Mn), or combination thereof; F′ may be fluorine (F), sulfur (S), phosphorus (P), or a combination thereof; G may be aluminum (Al), chromium (Cr), manganese (Mn), iron (Fe), magnesium (Mg), lanthanum (La), cerium (Ce), strontium (Sr), vanadium (V), or a combination thereof; Q may be titanium (Ti), molybdenum (Mo), manganese (Mn), or a combination thereof; I′ may be chromium (Cr), vanadium (V), iron (Fe), scandium (Sc), yttrium (Y), or a combination thereof; and J may be vanadium (V), chromium (Cr), manganese (Mn), cobalt (Co), nickel (Ni), copper (Cu), or a combination thereof. The compounds listed above as cathode active materials may have a coating layer on the surfaces thereof.

Alternatively, a mixture of a compound without a coating layer and a compound having a coating layer, the compounds being at least one of the compounds listed above, may be used. In some embodiments, the coating layer on the surface of such compounds may include at least one compound of a coating element of at least one of an oxide, hydroxide, oxyhydroxide, oxycarbonate, or hydroxycarbonate of the coating element. In some embodiments, the compounds for the coating layer may be amorphous or crystalline. In some embodiments, the coating element for the coating layer may be magnesium (Mg), aluminum (Al), cobalt (Co), potassium (K), sodium (Na), calcium (Ca), silicon (Si), titanium (Ti), vanadium (V), tin (Sn), germanium (Ge), gallium (Ga), boron (B), arsenic (As), zirconium (Zr), or a mixture thereof. In some embodiments, the coating layer may be formed using any method that does not adversely affect the physical properties of the cathode active material. For example, the coating layer may be formed using a spray coating method, a dipping method, or the like. The coating methods may be well understood by one of ordinary skill in the art, and thus a detailed description thereof will be omitted.

The cathode active material may include, for example, a lithium salt of a transition metal oxide having a layered rock salt-type structure among the above-listed lithium transition metal oxides. For example, the “layered rock-salt type structure” refers to a structure in which an oxygen atom layer and a metal atom layer are alternately and regularly disposed in a <111> direction in a cubic rock-salt type structure, where each of the atom layers forms a two-dimensional flat plane. A “cubic rock salt-type structure” refers to a sodium chloride (NaCl)-type crystal structure, and in particular, a structure in which face-centered cubic (fcc) lattices formed by respective cations and anions are disposed in a way those ridges of the unit lattices are shifted by ½. The lithium transition metal oxide with such a layered rock-salt type structure may be a ternary lithium transition metal oxide, for example, LiNiₓCo_{y}Al_{z}O₂(NCA) (wherein 0<x<1, 0<y<1, 0<z<1, and x+y+z=1) or LiNiₓCo_{y}Mn_{z}O₂(NCM) (wherein 0<x<1, 0<y<1, 0<z<1, and x+y+z=1). When the cathode active material includes such a ternary lithium transition metal oxide having a layered rock salt-type structure, the all-solid secondary battery 1 may have further improved energy density and thermal stability.

The cathode active material may be covered with a coating layer as described above. The coating layer may be any known coating layer for cathode active materials of all-solid secondary batteries. The coating layer may include, for example, Li₂O—ZrO₂.

When the cathode active material includes, for example, a ternary lithium transition metal oxide including Ni, such as NCA or NCM, the all-solid secondary battery 1 may have increased capacity density, and thus the elution of metal ions from the cathode active material may be reduced in a charged state. As a result, the all-solid secondary battery 1 may have improved cycle characteristics in a charged state.

The cathode active material may be in the form of particles having, for example, a true-spherical particle shape or an oval-spherical particle shape. The particle diameter of the cathode active material is not particularly limited, and may be in a range applicable to a cathode active material of an all-solid secondary battery according to the related art. An amount of the cathode active material in the cathode layer 10 is not particularly limited, and may be in a range applicable to a cathode active material of an all-solid secondary battery according to the related art.

The cathode layer 10 may further include, in addition to a cathode active material as described above, an additive(s), for example, a conductive material, a binder, a filler, a dispersing agent, an auxiliary ion-conductive material, or the like. The conductive material may be, for example, graphite, carbon black, acetylene black, Ketjen black, carbon fibers, metal powder, or the like. The binder may be, for example, a styrene-butadiene rubber (SBR), polytetrafluoroethylene, polyvinylidene fluoride, polyethylene, or the like. The dispersing agent, the auxiliary ion-conductive material, a coating agent, or the like which may be added to the cathode layer 10 may be any known materials commonly used in the cathode of an all-solid secondary battery.

The cathode layer 10 may further include a solid electrolyte. The solid electrolyte included in the cathode layer 10 may be similar to or different from the solid electrolyte included in the solid electrolyte layer 30. For details of the solid electrolyte, the above-detailed description of the solid electrolyte layer 30 may be referred to.

The solid electrolyte included in the cathode layer 10 may be, for example, a sulfide-based solid electrolyte. This sulfide-based solid electrolyte may be a sulfide-based solid electrolyte which may be used in the solid electrolyte layer 30.

In another embodiment, the cathode layer 10 may be, for example, impregnated with a liquid electrolyte. The liquid electrolyte may include a lithium salt and at least one of an ionic liquid and a polymeric ionic liquid. The liquid electrolyte may be non-volatile. The ionic liquid may refer to a salt in a liquid state at room temperature or a fused salt at room temperature, each having a melting point equal to or below the room temperature and consisting of only ions. The ionic liquid may include: a) at least one cation of at least one of an ammonium cation, a pyrrolidinium cation, a pyridinium cation, a pyrimidinium cation, an imidazolium cation, a piperidinum cation, a pyrazolium cation, an oxazolium cation, a pyridazinium cation, a phosphonium cation, a sulfonium cation, or a triazolium cation; and b) at least one anion of BF₄⁻, PF₆⁻, AsF₆⁻, SbF₆⁻, AlCl₄, HSO₄⁻, ClO₄⁻, CH₃SO₃⁻, CF₃CO₂⁻, Cl⁻, Br⁻, I⁻, BF₄⁻, SO₄⁻, CF₃SO₃⁻, (FSO₂)₂N⁻, (C₂F₅SO₂)₂N⁻, (C₂F₅SO₂)(CF₃SO₂)N⁻, of (CF₃SO₂)₂N. The ionic liquid may be, for example, at least one of N-methyl-N-propylpyrrolidium bis(trifluoromethylsulfonyl)imide, N-butyl-N-methylpyrrolidium bis(3-trifluoromethylsulfonyl)imide, 1-butyl-3-methylimidazolium bis(trifluoromethylsulfonyl)imide, or 1-butyl-3-methylimidazolium bis(trifluoromethylsulfonyl)imide). The polymeric ionic liquid may include repeating units including: a) at least one cation of ammonium cation, a pyrrolidinium cation, a pyridinium cation, a pyrimidinium cation, an imidazolium cation, a piperidinum cation, a pyrazolium cation, an oxazolium cation, a pyridazinium cation, a phosphonium cation, a sulfonium cation, or a triazolium cation; and b) at least one anion of BF₄⁻, PF₆⁻, AsF₆⁻, SbF₆⁻, AlCl₄⁻, HSO₄⁻, ClO₄⁻, CH₃SO₃⁻, CF₃CO₂⁻, (CF₃SO₂)₂N⁻, (FSO₂)₂N⁻, Cl⁻, Br⁻, I⁻, SO₄⁻, CF₃SO₃⁻, (C₂F₅SO₂)₂N⁻, (C₂F₅SO₂)(CF₃SO₂)N⁻, NO₃⁻, Al₂Cl₇⁻, (CF₃SO₂)₃C⁻, (CF₃)₂PF₄⁻, (CF₃)₃PF₃⁻, (CF₃)₄PF₂⁻, (CF₃)₅PF⁻, (CF₃)₆P⁻, SF₅CF₂SO₃⁻, SF₅CHFCF₂SO₃⁻, CF₃CF₂(CF₃)₂CO⁻, (CF₃SO₂)₂CH⁻, (SF₅)₃C⁻, or (O(CF₃)₂C₂(CF₃)₂O)₂PO⁻. The lithium salt may be any suitable lithium salt used in the art. For example, the lithium salt may be, for example, LiPF₆, LiBF₄, LiSbF₆, LiAsF₆, LiClO₄, LiCF₃SO₃, Li(CF₃SO₂)₂N, Li(FSO₂)₂N, LiC₄F₉SO₃, LiAlO₂, LiAlCl₄, LiN(CₓF₂ₓ₊₁SO₂)(C_{y}F_{2y+1}SO₂) (wherein x and y are each independently natural numbers), LiCl, LiI, or a mixture thereof. A concentration of the lithium salt in the liquid electrolyte may be about 0.1M to 5M. The amount of the liquid electrolyte impregnated in the cathode layer 10 may be about 0 or about 0.1 to 100 parts by weight, about 0 or about 0.1 to 50 parts by weight, about 0 or about 0.1 to 30 parts by weight, about 0 or about 0.1 to 20 parts by weight, about 0 or about 0.1 to 10 parts by weight, or about 0 or about 0.1 to 5 parts by weight, with respect to 100 parts by weight of the cathode active material layer 12 in which the liquid electrolyte is not included.

Method of Charging all-Solid Secondary Battery

According to one or more embodiments, a method of charging an all-solid secondary battery, the method being for charging the all-solid secondary battery according to the embodiments described above, includes charging to exceed a charge capacity of the first anode interlayer, wherein the all-solid secondary battery is charged so that a lithium precipitation layer that is precipitated on the anode layer has a thickness ranging from about 1 μm to about 100 μm.

Referring to FIGS. 1 to 4, first, when the all-solid secondary battery 1 is charged, charging is carried out to exceed a charge capacity of the first anode interlayer 22. That is, the first anode interlayer layer 22 is overcharged. At the initial stage of charging, the material capable of undergoing lithiation or delithiation that is included in the first anode interlayer 22 is lithiated. For example, the material capable of undergoing lithiation or delithiation that is included in the first anode interlayer 22 form an alloy or compound with lithium migrated from the cathode layer 10. When charging is carried out to exceed the capacity of the first anode interlayer 22, lithium is precipitated, for example, on the rear surface of the first anode interlayer 22, i.e., between the first anode interlayer 22 and the anode current collector 21, forming a lithium precipitation layer, which corresponds to a metal layer 24 formed of the precipitated lithium. The lithium precipitation layer is a metal layer including lithium (i.e., metal lithium) as a major component. During discharging, lithium in the first anode inter layer 22 and the metal layer 24, i.e., the lithium precipitation layer, is oxidized and moves toward the cathode layer 10. Accordingly, the all-solid secondary battery 1 may use lithium metal as the anode active material. Since the first anode interlayer 22 includes a first conductive binder and a second conductive binder, when lithium is precipitated and oxidized, a lithium ion conduction pathway and an electron conduction pathway may be easily secured between the solid electrolyte layer 30 and the anode layer. Accordingly, during the precipitation and oxidation of lithium, reversibility of the electrochemical reactions is improved, and thus, utilization rate of lithium which is the anode active material may be improved. The thickness of the lithium precipitation layer resulting from charging by the charging method may be, for example, about 1 μm to about 100 μm, about 1 μm to about 50 μm, about 1 μm to about 40 μm, about 1 μm to about 30 μm, or about 1 μm to about 20 μm. When the thickness of the lithium precipitation layer is too small, the lithium precipitation layer may not serve as a lithium reservoir. When the thickness of the lithium precipitation layer is too large, due to increase in resistance of the lithium precipitation layer, cycle characteristics of the all-solid secondary battery 1 may be deteriorated.

In the all-solid secondary battery 1 having the lithium precipitation layer that corresponds to the metal layer 24 arranged between the anode current collector 21 and the first anode interlayer 22 by the charging method described above, a region between the anode current collector 21 and the first anode interlayer 22 may be a Li-free region in which lithium is absent before charging or after discharging the all-solid secondary battery.

Method of Manufacturing all-Solid Secondary Battery

According to one or more embodiments, a method of manufacturing an all-solid secondary battery includes: providing a solid electrolyte layer having a first surface and an opposite second surface; arranging a first anode interlayer on the first surface of the solid electrolyte layer; and arranging a cathode active material layer on opposite second surface of the solid electrolyte layer.

Referring to FIGS. 1 to 4, a method of manufacturing the all-solid secondary battery 1 includes: providing a solid electrolyte layer 30; arranging a first anode interlayer 22 on the first surface of the solid electrolyte layer 30; and arranging a cathode active material layer 12 on the opposite second surface of the solid electrolyte layer 30. The first anode interlayer 22 includes a material capable of undergoing lithiation or delithiation, a first conductive binder, and a second conductive binder. Since the first anode interlayer 22 is arranged on the solid electrolyte layer 30, a short-circuit of the all-solid secondary battery 1 is suppressed and cycle characteristics of the all-solid secondary battery 1 are improved. For example, the all-solid secondary battery 1 may be manufactured by forming the first anode inter layer 22, the solid electrolyte layer 30, and the cathode layer 10, which are to be stacked on one another, and then stacking the layers. In addition, the method may further include, before the arranging of the first anode interlayer 22 on the first surface of the solid electrolyte layer, arranging a second anode interlayer on one surface of the solid electrolyte layer 30. Since the all-solid secondary battery 1 additionally includes the second anode interlayer 23, the all-solid secondary battery 1 may have further improved cycle characteristics.

### Preparation of Laminate of Solid Electrolyte Layer/Anode Layer

The first anode interlayer 22 may be arranged on the first surface of the solid electrolyte layer 30. The first anode interlayer 22 may be formed using a first anode interlayer slurry.

For example, carbon, a first conductive binder, and a second conductive binder, which constitute the first anode interlayer 22, are added to a polar solvent or a non-polar solvent to prepare a slurry. The prepared slurry is coated and dried on one surface of the prepared solid electrolyte layer 30 to prepare a first laminate. Subsequently, the anode current collector 21 may be disposed on the dried first laminate and then pressed to thereby form a laminate of the solid electrolyte layer 30, the first anode interlayer 22, and the anode current collector 21. The pressing may be carried out using, for example, roll pressing, flat pressing, warm isostatic pressing (WIP), cold isostatic pressing (CIP), or the like. However, embodiments are not limited to these methods, and any suitable pressing method used in the art may be used. A pressure applied in the pressing may be, for example, about 50 megapascals (MPa) to 500 MPa. The pressing time for which a pressure is applied may be about 5 milliseconds (ms) to about 10 min. The pressing may be carried out, for example, at a temperature from room temperature to 90° C. or less, or at a temperature from 20 to 90° C. In another embodiment, the pressing may be carried out at a high temperature of 100° C. or greater.

A metal layer 24 may be additionally disposed between the first anode interlayer 22 and the anode current collector 21. For example, the metal layer 24 may be a lithium foil. For example, a lithium foil and the anode current collector 21 may be sequentially arranged on the dried first laminate and pressed to thereby prepare a laminate of the solid electrolyte layer 30, the first anode interlayer 22, the metal layer 24, and the anode current collector 21.

In other embodiments, before the first anode interlayer 22 is arranged on the first surface of the solid electrolyte layer 30, the second anode interlayer 23 may be additionally arranged.

The second anode interlayer 23 may be a metal layer including a second metal. The second anode interlayer 23 may be prepared by coating a second metal on the first surface of the solid electrolyte layer 30 by a method, such as sputtering, vacuum deposition, plating, or the like. In other embodiments, the second anode interlayer may be prepared by arranging and pressing a foil of the second metal on the first surface of the solid electrolyte layer 30. The pressing may be omitted. The pressing may be carried out using the same method as applied to the first anode interlayer 22.

Subsequently, the first anode interlayer 22 and the anode current collector 21 are sequentially arranged on the second anode interlayer 23 and pressed to manufacture a laminate of the solid electrolyte layer 30 and the anode layer 20. The pressing may be carried out using the same method as applied to the first anode interlayer 22.

A metal layer 24 may be additionally disposed between the first anode interlayer 22 and the anode current collector 21. For example, the metal layer 24 may be a lithium foil. For example, on a laminate of the second anode interlayer 23 and the first anode interlayer 22, a lithium foil and the anode current collector 21 may be sequentially arranged and pressed to prepare a laminate of the solid electrolyte layer 30, the second anode interlayer 23, the first anode interlayer 22, the metal layer 24, and the anode current collector 21.

### Preparation of Cathode Layer

A cathode active material, a binder, and the like as constituent materials of the cathode active material layer 12 is added to a polar solvent to prepare a slurry. The prepared slurry may be coated on the cathode current collector 11 and then dried to form a laminate. The obtained laminate may be pressed to thereby form the cathode layer 10. For example, the pressing may be performed using, for example, roll pressing, flat pressing, or isostatic pressing. However, embodiments are not limited thereto, and any suitable pressing method available in the art may be used. The pressing may be omitted. In other embodiments, the cathode layer 10 may be formed by compaction-molding a mixture of the constituent materials of the cathode active material layer 12 into pellets or extending the mixture into a sheet form. When these methods are used to form the cathode layer 10, the cathode current collector 11 may be omitted. In other embodiments, the cathode layer 10 may be impregnated with a liquid electrolyte before use.

### Preparation of Solid Electrolyte Layer

For example, the solid electrolyte layer 30 including an oxide-based solid electrolyte may be prepared by thermally treating precursors of an oxide-based solid electrolyte material.

The oxide-based solid electrolyte may be prepared by contacting the precursors in stoichiometric amounts to form a mixture and thermally treating the mixture. For example, the contacting may include milling such as ball milling, or grinding. The mixture of the precursors mixed in a stoichiometric composition may be subjected to first thermal treatment under oxidizing atmosphere to prepare a first thermal treatment product. The first thermal treatment may be carried out in a temperature range less than 1000° C. for about 1 to 36 hours. The first thermal treatment product may be ground. The first thermal treatment product may be ground in a wet or dry manner. For example, the wet milling may be carried out by mixing the first thermal treatment product with a solvent such as methanol and milling the mixture using, for example, a ball mill for about 0.5 to 10 hours. Dry grinding may be performed using, for example, a ball mill without solvent. The ground first thermal treatment product may have a particle diameter of about 0.1 μm to about 10 μm, or about 0.1 μm to about 5 μm. The ground first thermal treatment product may be dried. The ground first thermal treatment product may be shaped into a pellet form by being mixed with a binder solution, or may be shaped into a pellet form by simply being pressed at a pressure of about 1 ton to about 10 tons.

The shaped product may be subjected to second thermal treatment at a temperature of less than 1000° C. for about 1 hour to 36 hours. Through the second thermal treatment, the solid electrolyte layer 30, which is a sintered product, may be obtained. The second thermal treatment may be carried out, for example, at a temperature of about 550° C. to 1000° C. For example, the first thermal treatment time may be about 1 to 36 hours. The second thermal treatment temperature for obtaining the sintered product may be higher than the first thermal treatment temperature. For example, the second thermal treatment temperature may be higher than the first thermal treatment temperature by about 10° C. or greater, about 20° C. or greater, about 30° C. or greater, or about 50° C. or greater. The second thermal treatment of the shaped product may be carried out under at least one of oxidizing atmosphere and reducing atmosphere. The second thermal treatment may be carried out under a) oxidizing atmosphere, b) reducing atmosphere, or c) oxidizing and reducing atmosphere.

For example, the solid electrolyte layer 30 including a sulfide-based solid electrolyte may be prepared using a solid electrolyte including a sulfide-based solid electrolyte material.

The sulfide-based solid electrolyte may be prepared by treatment of a source material with, for example, melt quenching or mechanical milling. However, embodiments are not limited thereto. Any suitable method of preparing a sulfide-based solid electrolyte available in the art may be used. For example, in the case of using melt quenching, after predetermined amounts of source materials such as Li₂S and P₂S₅ are mixed together and then made into pellets, the pellets may be subjected to reaction at a predetermined reaction temperature under vacuum conditions and then quenched to thereby prepare a sulfide-based solid electrolyte. The reaction temperature of the mixture of Li₂S and P₂S₅ may be, for example, about 400° C. to 1000° C., or about 800° C. to 900° C. The reaction time may be, for example, about 0.1 hours to about 12 hours, or about 1 hour to about 12 hours. The quenching temperature of the reaction product may be about 10° C. or less or about 0° C. or less, and the quenching rate may be about 1° C./sec to about 10,000° C./sec, or about 1° C./sec to about 1,000° C./sec. For example, in the case of using mechanical milling, the source materials such as Li₂S and P₂S₅ may be reacted while stirring using, for example, a ball mill, to thereby prepare a sulfide-based solid electrolyte. The stirring rate and stirring time in the mechanical milling are not specifically limited. The higher the stirring rate, the production rate of the sulfide-based solid electrolyte may become higher. The longer the stirring time, the rate of conversion of the source material into the sulfide-based solid electrolyte may become higher. Then, the mixture of the source materials, obtained by melting quenching or mechanical milling, may be thermally treated at a predetermined temperature and then ground to thereby prepare a solid electrolyte in the form of particles. When the solid electrolyte has glass transition characteristics, the solid electrolyte may be converted from an amorphous form to a crystalline form by thermal treatment.

The solid electrolyte obtained through such a method as described above may be deposited using a known film formation method, for example, an aerosol deposition method, a cold spraying method, or a sputtering method, to thereby prepare the solid electrolyte layer 30. In one or more embodiments, the solid electrolyte layer 30 may be prepared by pressing single-element solid electrolyte particles alone. In other embodiments, the solid electrolyte layer 30 may be formed by mixing a solid electrolyte, a solvent, and a binder together to obtain a mixture, and coating, drying, and then pressing the mixture.

Manufacture of all-Solid Secondary Battery

The cathode layer 10, and the laminate of the anode layer 20 and the solid electrolyte layer 30, which are formed according to the above-described method, may be stacked such that the solid electrolyte layer 30 is disposed between the cathode layer 10 and the anode layer 20, and then be pressed to thereby manufacture the all-solid secondary battery 1.

For example, the laminate of the anode layer 20 and the solid electrolyte layer 30 may be arranged on the cathode layer 10 such that the solid electrolyte layer 30 contacts the cathode layer 10, to thereby prepare a second laminate. The second laminate may then be pressed to thereby manufacture the all-solid secondary battery 1. For example, the pressing may be performed using, for example, roll pressing, flat pressing, or isostatic pressing. However, embodiments are not limited thereto, and any suitable pressing method available in the art may be used. A pressure applied in the pressing may be, for about 50 MPa to about 750 MPa, or about 100 MPa to about 500 MPa. The pressing time for which a pressure is applied may be about 5 milliseconds (ms) to about 5 minutes (min), or about 1 second to about 1 minute. The pressing may be carried out, for example, at a temperature from room temperature to 90° C. or less, or at a temperature from 20 to 90° C. In other embodiments, the pressing may be carried out at a high temperature of 100° C. or greater. Although the structures of the all-solid secondary battery 1 and the methods of manufacturing the all-solid secondary battery 1 are described above as embodiments, the disclosure is not limited thereto, and the constituent members of the all-solid secondary battery and the manufacturing processes may be appropriately varied. The pressing may be omitted.

Substituents in the formulae above may be defined as follows.

As used herein, the term “alkyl” indicates a monovalent or higher valency group derived from a completely saturated, branched or unbranched (or a straight or linear) hydrocarbon, and having the specified number of carbon atoms.

Non-limiting examples of the “alkyl” group are methyl, ethyl, n-propyl, isopropyl, n-butyl, isobutyl, sec-butyl, t-butyl, isopentyl, neopentyl, n-hexyl, 3-methylhexyl, 2,2-dimethylpentyl, 2,3-dimethylpentyl, and n-heptyl.

At least one hydrogen atom of the alkyl group may be substituted with a halogen atom, a C1-C30 alkyl group substituted with a halogen atom (for example, —CF₃, —CHF₂, —CH₂F, —CCl₃, and the like), a C1-C30 alkoxy group, a C2-C30 alkoxyalkyl group, a hydroxyl group, a nitro group, a cyano group, an amino group, an amido group, a hydrazine group, a hydrazone group, a carboxyl group or a salt thereof, a sulfonyl group, a sulfamoyl group, a sulfonic acid group or a salt thereof, a phosphoric acid group or a salt thereof, a C1-C30 alkyl group, a C2-C30 alkenyl group, a C2-C30 alkynyl group, a C1-C30 heteroalkyl group, a C6-C30 aryl group, a C7-C30 arylalkyl group, a C2-C30 heteroaryl group, a C3-C30 heteroarylalkyl group, a C2-C30 heteroaryloxy group, a C3-C30 heteroaryloxyalkyl group, or a C6-C30 heteroarylalkyloxy group.

As used herein, the term “halogen atom” indicates fluorine, bromine, chloride, iodine, and the like.

As used herein, the term “C1-C30 alkyl group substituted with a halogen atom” indicates a C1-C30 alkyl group substituted with at least one halogen atom. Non-limiting examples of the C1-C30 alkyl group substituted with at least one halogen atom are polyhaloalkyls including monohaloalkyl, dihaloalkyl, or perhaloalkyl.

As used herein, the term “monohaloalkyl” indicates an alkyl group including one iodine, bromine, chlorine or fluorine atom. The terms “dihaloalkyl” and “polyhaloalkyl” indicate alkyl groups including at least two identical or different halogen atoms. The term “perhaloalkyl” indicates an alkyl group wherein all of the hydrogens are substituted with the same or different halogen atoms.

As used herein, the term “alkoxy” indicates “alkyl-O—”, wherein the alkyl is the same as described above and having the specified number of carbon atoms. Non-limiting examples of the alkoxy group include methoxy, ethoxy, propoxy, 2-propoxy, butoxy, t-butoxy, pentyloxy, hexyloxy, cyclopropoxy, and cyclohexyloxy. At least one hydrogen atom of the alkoxy group may be substituted with substituents that are the same as those recited above in conjunction with the alkyl group.

As used herein, the term “aryl” group, which is used alone or in combination, indicates an aromatic hydrocarbon containing at least one ring.

The term “aryl” includes a group with an aromatic ring fused to at least one cycloalkyl ring.

Non-limiting examples of the “aryl” group include phenyl, naphthyl, and tetrahydronaphthyl.

At least one hydrogen atom of the “aryl” group may be substituted with substituents that are the same as those recited above in conjunction with the alkyl group.

As used herein, the term “arylalkyl” indicates an alkyl group substituted with an aryl group. Non-limiting examples of the “arylalkyl” group include benzyl, phenyl-CH₂CH₂—, and the like.

The term “arylalkylene” refers to a straight or branched chain, saturated, divalent hydrocarbon group substituted with an aryl group.

As used herein, the term “aryloxy” indicates “—O-aryl” or “—O-aryl-” A non-limiting example of the aryloxy group is phenoxy. At least one hydrogen atom of the “aryloxy” group may be substituted with substituents that are the same as those recited above in conjunction with the alkyl group.

As used herein, the term “heteroaryl group” indicates a monocyclic or bicyclic aromatic organic compound including at least one heteroatom of nitrogen (N), oxygen (O), phosphorous (P), or sulfur (S), the rest of the cyclic atoms being carbon. The heteroaryl group may include, for example, one to five heteroatoms, and in some embodiments, may include a 5-10-membered ring.

In the heteroaryl group, S or N may be present in various oxidized forms.

Non-limiting examples of a monocyclic heteroaryl group include thienyl, furyl, pyrrolyl, imidazolyl, pyrazolyl, thiazolyl, isothiazolyl, 1,2,3-oxadiazolyl, 1,2,4-oxadiazolyl, 1,2,5-oxadiazolyl, 1,3,4-oxadiaxolyl, 1,2,3-thiadiazolyl, 1,2,4-thiadiazolyl, 1,2,5-thiadiazolyl, 1,3,4-thiazolyl, isothiazol-3-yl, isothiazol-4-yl, isothiazol-5-yl, oxazol-2-yl, oxazol-4-yl, oxazol-5-yl, isoxazol-3-yl, isoxazol-4-yl, isoxazol-5-yl, 1,2,4-triazol-3-yl, 1,2,4-triazol-5-yl, 1,2,3-triazol-4-yl, 1,2,3-triazol-5-yl, tetrazolyl, pyrid-2-yl, pyrid-3-yl, 2-pyrazin-2-yl, pyrazin-4-yl, pyrazin-5-yl, 2-pyrimidin-2-yl, 4-pyrimidin-2-yl, and 5-pyrimidin-2-yl.

The term “heteroaryl” is construed to include a heteroaromatic ring fused to at least one of an aryl group, a cycloaliphatic group, and a heterocyclic group.

Non-limiting examples of a bicyclic heteroaryl group are indolyl, isoindolyl, indazolyl, indolizinyl, purinyl, quinolizinyl, quinolinyl, isoquinolinyl, cinnolinyl, phthalazinyl, naphthyridinyl, quinazolinyl, quinolo[4,3-d]pyridinyl, pyrazolo[4,3-c]pyridinyl, pyrazolo[3,4-c]pyridinyl, pyrazolo[3,4-d]pyridinyl, pyrazolo[3,4-b]pyridinyl, imidazo[1,2-a]pyridinyl, pyrazolo[1,5-a]pyridinyl, pyrrolo[1,2-b]pyridazinyl, imidazo[1,2-c]pyrimidinyl, pyrido[3,2-d]pyrimidinyl, pyrido[4,3-d]pyrimidinyl, pyrido[3,4-d]pyrimidinyl, pyrido[2,3-d]pyrimidinyl, pyrido[2,3-b]pyrazinyl, pyrido[3,4-b]pyrazinyl, pyrimido[5,4-d]pyrimidinyl, pyrazino[2,3-b]pyrazinyl, and pyrimido[4,5-d]pyrimidinyl.

At least one hydrogen atom of the “heteroaryl” group may be substituted with substituents that are the same as those recited above in conjunction with the alkyl group.

As used herein, the term “heteroarylalkyl” group indicates an alkyl group substituted with a heteroaryl group.

The term “heteroarylalkylene” refers to a straight or branched chain, saturated, divalent hydrocarbon group substituted with a heteroaryl group.

As used herein, the term “heteroaryloxy” indicates “—O-heteroaryl” or “—O— heteroaryl-” moiety. At least one hydrogen atom of the heteroaryloxy group may be substituted with substituents that are the same as those recited above in conjunction with the alkyl group.

As used herein, the term “carbocyclic” group indicates a monovalent or a divalent saturated or partially unsaturated non-aromatic monocyclic, bicyclic or tricyclic hydrocarbon group.

Non-limiting examples of a monocyclic hydrocarbon group include cyclopentyl, cyclopentenyl, cyclohexyl, and cyclohexenyl.

Non-limiting examples of a bicyclic hydrocarbon group include bornyl, decahydronaphthyl, bicyclo[2.1.1]hexyl, bicyclo[2.2.1]heptyl, bicyclo[2.2.1]heptenyl, and bicyclo[2.2.2]octyl.

A non-limiting example of a tricyclic hydrocarbon group is adamantyl.

At least one hydrogen atom of the “carbocyclic group” may be substituted with substituents that are the same as those recited above in conjunction with the alkyl group.

As used herein, the term “heterocyclic group” indicates a five- to ten-membered carbocyclic group including a heteroatom such as N, S, P, or O. A non-limiting example of the heterocyclic group is pyrrolidinyl, or the like. At least one hydrogen atom in the heterocyclic group may be substituted with substituents that are the same as those recited above in conjunction with the alkyl group.

The term “carbocyclic alkylene group” refers to a divalent straight or branched chain, saturated, divalent hydrocarbon group substituted with a carbocyclic group.

The term “carbocyclic alkyl group” refers to an alkyl group substituted with a carbocyclic group.

The term “sulfonyl” indicates R″—SO₂—, wherein R″ is a hydrogen atom, alkyl, aryl, heteroaryl, aryl-alkyl, heteroaryl-alkyl, alkoxy, aryloxy, cycloalkyl, or a heterocyclic group.

The term “sulfamoyl” group indicates H₂NS(═O)₂—, alkyl-NHS(═O)₂—, (alkyl)₂NS(═O)₂-aryl-NHS(═O)₂—, alkyl-(aryl)-NS(═O)₂—, (aryl)₂NS(═O)₂—, heteroaryl-NHS(═O)—, (aryl-alkyl)-NHS(═O)₂—, or (heteroaryl-alkyl)-NHS(═O)₂—.

The term “amino group” indicates a group with a nitrogen atom covalently bonded to at least one carbon or hetero atom. The amino group may include, for example, a —NH₂ group with optionally substituted moieties.

The term “alkylamino group” may include an amino group with nitrogen bound to at least one additional alkyl group, and an arylamino group and a diarylamino group with at least one or two nitrogen atoms bound to an independently selected aryl group.

One or more embodiments of the present disclosure will now be described in detail with reference to the following examples. However, these examples are only for illustrative purposes and are not intended to limit the scope of the one or more embodiments of the present disclosure.

### EXAMPLES

### Example 1: LITX 200/CB35, LiPAA+PEDOT:PSS

### Preparation of Laminate of Solid Electrolyte Layer/Anode Layer

Li_{6.5}La₃Zr_{1.5}Ta_{0.5}O₁₂ pellets (hereinafter, LLZO pellets) having a diameter of 14 mm and a thickness of 500 μm were prepared. The LLZO pellets were treated with 1 mol/L of hydrochloric acid for 40 min and vacuum dried for use.

LITX 200 (Cabot corporation) and CB35 (Asahi Carbon), as carbon, lithium polyacrylic acid (LiPAA) (having a viscosity average molecular weight of 1.25 M Daltons or 1,250,000 Daltons), which is an ion-conductive polymer, as a first conductive binder, and an electron-conductive polymer PEDOT:PSS as a second conductive binder were prepared.

The lithium polyacrylic acid (LiPAA) includes a repeating unit represented by Formula a:

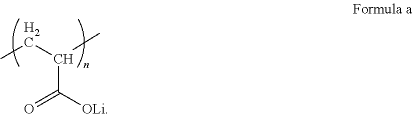

LITX 200 and CB35 were put into a vessel, an aqueous lithium polyacrylic acid solution and an aqueous PEDOT:PSS solution were added thereto and stirred to prepare a slurry for forming a first anode interlayer.

LITX 200, CB35, lithium polyacrylic acid (LiPAA), and PEDTO:PSS were mixed in a weight ratio of 25:75:5:5 on a solid content basis.

The prepared slurry was coated on the LLZO pellets using a blade coater, dried in the air at 80° C. for about 20 minutes, and then vacuum-dried at 100° C. for about 12 hours to thereby form a first anode interlayer. The first anode interlayer had a thickness of about 8 um.

A lithium coil of a thickness of 20 μm was arranged on the first anode interlayer and a pressure of 250 MPa was applied thereto at 25° C. by cold isostatic pressing (CIP) to attach the first anode interlayer and a lithium metal layer to the LLZO. The lithium metal layer was an anode active material layer.

An anode current collector consisting of a SUS (stainless steel) 304 thin film of 10 μm was arranged on the lithium metal layer and then attached by applying a pressure of 250 MPa at 25° C. by CIP, to thereby prepare a stack of solid electrolyte/anode layer.

### Preparation of Cathode Layer

LiNi_{0.8}Co_{0.1}Al_{0.1}O₂(NCA) as a cathode active material, polyvinylidene fluoride as a binder, and carbon black as a conductive material were prepared. Then, the cathode active material, the conductive material, and the binder were mixed in a mass ratio of 97:1:2 in a NMP solvent. The mixture was coated on an aluminum foil cathode current collector to thereby form a cathode layer.

The cathode anode active material layer of the formed cathode layer was impregnated with a liquid electrolyte including 2.0M of LiFSI dissolved in ionic liquid Pyr13FSI (N-propyl-N-methyl-pyrrolidinium bis(fluorosulfonyl)imide).

Manufacture of all-Solid Secondary Battery

The cathode layer was disposed such that the cathode active material layer impregnated with the ionic liquid electrolyte faced an upper end in a SUS cap. The stack of solid electrolyte layer/anode layer was disposed such that the solid electrolyte layer was located on the cathode active material layer, and then sealed to thereby manufacture an all-solid secondary battery.

The cathode layer and the anode layer were insulated using an insulator. Parts of the cathode current collector and the anode current collector were made to protrude out of the sealed battery and used as a cathode layer terminal and an anode layer terminal, respectively.

### Example 2: LITX 200/CB35, LiPEMA+PEDOT:PSS

An all-solid secondary battery was manufactured in the same manner as in Example 1, except that Li-poly(ethylene-alt-maleic acid) (PEMA, weight average molecular weight of 40 K Daltons, or 4,000 Daltons), instead of the ion-conductive polymer lithium polyacrylic acid (LiPAA), was used as the first conductive binder. The Li-poly(ethylene-alt-maleic acid) (PEMA) includes a repeating unit represented by Formula b:

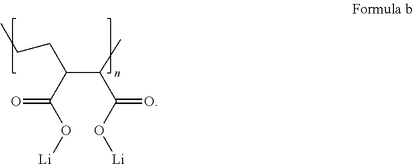

LITX 200, CB35, Li-poly(ethylene-alt-maleic acid), and PEDTO:PSS were mixed in a weight ratio of 25:75:5:5 on a solid content basis.

### Example 3: CB1/CB35, LiPAA+PEDOT:PSS

An all-solid secondary battery was manufactured in the same manner as in Example 1, except that CB1 (Asahi Carbon), instead of LITX 200 (Cabot corporation), was used as the carbon.

CB1, CB35, lithium polyacrylic acid (LiPAA), and PEDTO:PSS were mixed in a weight ratio of 25:75:5:5 on a solid content basis.

### Comparative Example 1: LITX 200/CB35, PVDF

An all-solid secondary battery was manufactured in the same manner as in Example 1, except that polyvinylidene fluoride (PVDF) was used alone as the binder.

LITX 200, CB35, and polyvinylidene fluoride (PVDF) were mixed in a weight ratio of 25:75:10 on a solid content basis.

### Comparative Example 2: CB1/CB35, PVDF

An all-solid secondary battery was manufactured in the same manner as in Example 1, except that CB1 (Asahi Carbon), instead of LITX 200 (Cabot corporation), was used as the carbon, and polyvinylidene fluoride (PVDF) was used alone as the binder.

CB1, CB35, and polyvinylidene fluoride (PVDF) were mixed in a weight ratio of 25:75:10 on a solid content basis.

### Example 4: CB35, LiPAA+PEDOT:PSS

An all-solid secondary battery was manufactured in the same manner as in Example 1, except that a silver (Ag) layer as a second anode interlayer was added between the solid electrolyte layer and the first anode interlayer, CB35 (Asahi Carbon) was used alone as the carbon, and the amount of lithium polyacrylic acid (LiPAA) was changed to 100 parts by weight. The second interlayer was introduced by sputtering an Ag layer having a thickness of 200 nm onto the LLZO pellets.

CB35, LiPAA, and PEDTO:PSS were mixed in a weight ratio of 100:10:5 on a solid content basis.

### Example 5: CB35, LiPEMA+PEDOT:PSS

An all-solid secondary battery was manufactured in the same manner as in Example 2, except that a silver (Ag) layer as a second anode interlayer was added between the solid electrolyte layer and the first anode interlayer, CB35 (Asahi Carbon) was used alone as the carbon, and the amount of Li-poly(ethylene-alt-maleic acid) (LiPEMA) was changed to 100 parts by weight. The second interlayer was introduced on the LLZO pellets by forming an Ag layer having a thickness of 200 nm by sputtering.

CB35, LiPEMA, and PEDTO:PSS were mixed in a weight ratio of 100:10:5 on a solid content basis.

### Comparative Example 3: CB35, PVDF

An all-solid secondary battery was manufactured in the same manner as in Example 1, except that a silver (Ag) layer as a second anode interlayer was added between the solid electrolyte layer and the first anode interlayer, CB35 (Asahi Carbon) was used alone as the carbon, and polyvinylidene fluoride (PVDF) was used alone as the binder. The second interlayer was introduced on the LLZO pellets by forming an Ag layer having a thickness of 200 nm by sputtering.

CB35, and PVDF were mixed in a weight ratio of 100:15 on a dry content basis.

### Evaluation Example 1: Room Temperature Charge-Discharge Test, High-Rate Capability

A charge-discharge test was carried out on the all-solid secondary batteries manufactured in Examples 1 to 5 and Comparative Examples 1 to 3.

The all-solid secondary batteries manufactured in Examples 1 to 5 and Comparative Examples 1 to 3 were charged with a constant current of 0.5 mA/cm² at 25° C. until a voltage of 4.3 V (vs. Li) was reached, charged at a constant voltage of 4.3 V (vs. Li) until a current of 0.05 mA/cm² was reached, and then discharged with a constant current of 0.5 mA/cm² until a voltage of 2.85 V (vs. Li) was reached. This cycle was repeated three times (1^{st} cycle to 3^{rd} cycle).

Subsequently, the all-solid secondary batteries were charged with a constant current of 0.8 mA/cm² at 25° C. until a voltage of 4.3 V (vs. Li) was reached, charged at a constant voltage of 4.3 V (vs. Li) until a current of 0.08 mA/cm² was reached, and then discharged with a constant current of 0.8 mA/cm² until a voltage of 2.85 V (vs. Li) was reached. This cycle was repeated three times (4^{th} cycle to 6^{th} cycle).

Subsequently, the all-solid secondary batteries were charged with a constant current of 1.0 mA/cm² at 25° C. until a voltage of 4.3 V (vs. Li) was reached, charged at a constant voltage of 4.3 V (vs. Li) until a current of 0.1 mA/cm² was reached, and then discharged with a constant current of 1.0 mA/cm² until a voltage of 2.85 V (vs. Li) was reached. This cycle was repeated three times (7^{th} cycle to 9^{th} cycle).

Subsequently, the all-solid secondary batteries were charged with a constant current of 1.6 mA/cm² at 25° C. until a voltage of 4.3 V (vs. Li) was reached, charged at a constant voltage of 4.3 V (vs. Li) until a current of 0.16 mA/cm² was reached, and then discharged with a constant current of 1.6 mA/cm² until a voltage of 2.85 V (vs. Li) was reached. This cycle was repeated three times (10^{th} cycle to 12^{th} cycle).

Subsequently, the all-solid secondary batteries were charged with a constant current of 2.0 mA/cm² at 25° C. until a voltage of 4.3 V (vs. Li) was reached, charged at a constant voltage of 4.3 V (vs. Li) until a current of 0.2 mA/cm² was reached, and then discharged with a constant current of 2.0 mA/cm² until a voltage of 2.85 V (vs. Li) was reached. This cycle was repeated three times (13^{th} cycle to 15^{th} cycle).

A rest period of 10 min was allowed after each charging/discharging cycle throughout the entire charging/discharging cycles. Some results of the charge-discharge test at room temperature are represented in Table 1. A high-rate capability is defined by Equation 2:

High-rate capability [%]=[Discharge capacity at 13^{th} cycle/Discharge capacity at 1^{st} cycle]×100. Equation 2

TABLE 1

| | High-rate |
|---|---|
| | capability [%] |
| | (2.0 mA/cm²/ |
| | 0.5 mA/cm²) |
| Example 1 | 78.9 |
| Example 2 | 79.9 |
| Comparative | 78.2 |
| Example 1 | |
| Example 3 | 85.0 |
| Comparative | 82.9 |
| Example 2 | |
| Example 4 | 85.1 |
| Example 5 | 86.2 |
| Comparative | 84.6 |
| Example 3 | |

As shown in Table 1, the all-solid secondary batteries of Examples 1 and 2 in which the anode interlayers included an ion-conductive polymer and an electron-conductive polymer at the same time, had improved high-rate capabilities compared to the all-solid secondary battery in which the anode interlayer had the same carbon composition and included the insulating polymer.

The all-solid secondary battery of Example 3 in which the anode interlayer included an ion-conductive polymer and an electron-conductive polymer at the same time, had improved high-rate capability compared to the all-solid secondary battery of

### Comparative Example 2 in which the Anode Interlayer had the Same Carbon Composition and Included an Insulating Polymer

The all-solid secondary batteries of Examples 4 and 5 in which the anode interlayers included an ion-conductive polymer and an electron-conductive polymer at the same time, had improved high-rate capability compared to the all-solid secondary battery of Comparative Example 3 in which the anode interlayer had the same carbon composition and included an insulating polymer.

### Evaluation Example 2: Room Temperature Charge-Discharge Test, Lifespan Characteristics

After the high-rate capability evaluation was complete, a lifespan characteristic test was further carried out on the all-solid secondary batteries manufactured in Examples 1 to 5 and Comparative Examples 1 to 3.

The all-solid secondary batteries manufactured in Examples 1 to 5 and Comparative Examples 1 to 3 were charged with a constant current of 2.0 mA/cm² at 25° C. until a voltage of 4.3 V (vs. Li) was reached, charged at a constant voltage of 4.3 V (vs. Li) until a current of 0.2 mA/cm² was reached, and then discharged with a constant current of 2.0 mA/cm² until a voltage of 2.85 V (vs. Li) was reached. This cycle was repeated 100 times.

A rest period of 10 min was allowed after each charging/discharging cycle throughout the entire charging/discharging cycles. Some results of the charge-discharge test at room temperature are represented in Table 2. A capacity retention ratio at 100^{th} cycle is defined by Equation 3:

Capacity retention [%]=[Discharge capacity at 100^{th} cycle/Discharge capacity at 1^{st} cycle]×100%. Equation 3

TABLE 2

| | Capacity retention [%] |
|---|---|
| Example 1 | 94.6 |
| Example 2 | 95.6 |
| Comparative | 84.4 |
| Example 1 | |
| Example 3 | 96.0 |
| Comparative | Voltage was unstable |
| Example 2 | after 30 cycles |
| Example 4 | 100.0 |
| Example 5 | 100.0 |
| Comparative | Voltage was unstable |
| Example 3 | after 20 cycles |
| | and a short circuit |
| | occurred at 45 cycles. |

As shown in Table 2, the all-solid secondary batteries of Examples 1 and 2 in which the anode interlayers included an ion-conductive polymer and an electron-conductive polymer at the same time, provided excellent lifespan characteristics of 95% or greater.

The all-solid secondary batteries of Examples 4 and 5 in which a silver (Ag) layer was further included as a second anode interlayer had further improved lifespan characteristics.

However, the all-solid secondary battery of Comparative Example 1 in which the anode interlayer included the insulating polymer had poor lifespan characteristics, the all-solid secondary battery of Comparative Example 2 exhibited voltage instability, and a short-circuit occurred in the all-solid secondary battery of Comparative Example 3 during charging/discharging processes.

As described above, the all-solid secondary battery according to any of the above-described embodiments may be applied to various portable devices or vehicles.

Embodiments of the present disclosure have been described with reference to the appended drawings, the present disclosure is not limited thereto. It would be obvious for a person skilled in the art to which the present technical idea belong to derive various changed examples or modified examples within the scope of the spirit set forth in the following claims, and these examples should be construed as falling within the scope of the technical idea of the present disclosure.

According to an aspect, since an anode interlayer includes lithium-substituted ion-conductive polymer and electron-conductive polymer, increases in internal resistance in the anode interlayer and the anode are suppressed, and uniformity of current density and uniformity of lithium ion migration are improved.

Using the anode interlayer, an all-solid secondary battery may be provided that may suppress a short-circuit caused by the growth of lithium dendrites during charging and discharging, and may have improved high-rate capability and lifespan characteristics.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. An anode interlayer for an all-solid secondary battery, the anode interlayer comprising:
a material capable of undergoing lithiation and delithiation;
a first conductive binder; and
a second conductive binder,
wherein the material capable undergoing lithiation and delithiation comprises carbon or a combination of carbon and a first metal,
the first conductive binder comprises an ion-conductive polymer, the ion-conductive polymer comprises lithium as a substituent, and
the second conductive binder comprises an electron-conductive polymer.

2. The anode interlayer of claim 1, wherein
the ion-conductive polymer comprises a lithium-containing functional group, and
the lithium-containing functional group is —C(═O)OLi, —OS(═O)₂OLi, —S(═O)₂OLi, —S(═O)OLi, —OP(═O)(OH)OLi, —OP(═O)(OLi)₂, —P(═O)(OH)OLi, —P(═O)(OLi)₂, or a combination thereof.

3. The anode interlayer of claim 1, wherein an amount of the lithium-containing functional group is about 50 mol % to about 100 mol % with respect to a total moles of an acidic functional group included in the ion-conductive polymer.

4. The anode interlayer of claim 1, wherein the ion-conductive polymer comprises a first repeating unit represented by Formula 1 and a second repeating unit represented by Formula 2: 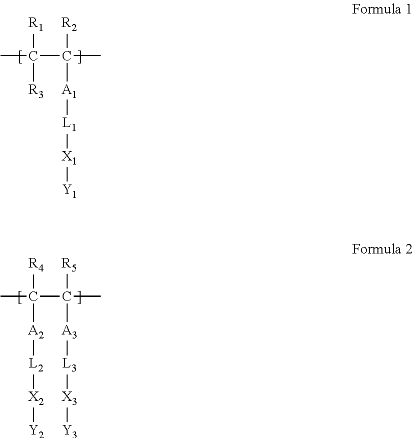
wherein, in Formulae 1 and 2,
A₁, A₂, and A₃ are each independently a single bond or —(C═O)—N(Ra)—,
L₁, L₂, and L₃ are each independently a single bond, a substituted or unsubstituted C1-C30 alkylene group, a substituted or unsubstituted C2-C30 alkenylene group, a substituted or unsubstituted C2-C30 alkynylene group, a substituted or unsubstituted C6-C30 arylene group, a substituted or unsubstituted C7-C30 arylalkylene group, a substituted or unsubstituted C2-C30 heteroarylene group, a substituted or unsubstituted C3-C30 heteroarylalkylene group, a substituted or unsubstituted C4-C30 carbocyclic group, a substituted or unsubstituted C5-C30 carbocyclic alkylene group, a substituted or unsubstituted C2-C30 heterocyclic group, or a substituted or unsubstituted C3-C30 heterocyclic alkylene group,
R₁, R₂, R₃, R₄, R₅, and Ra are each independently a hydrogen atom, a substituted or unsubstituted C1-C30 alkyl group, a substituted or unsubstituted C1-C30 alkoxy group, a substituted or unsubstituted C1-C30 alkylthio group, a substituted or unsubstituted C2-C30 alkenyl group, a substituted or unsubstituted C2-C30 alkynyl group, a substituted or unsubstituted C6-C30 aryl group, a substituted or unsubstituted C6-C30 aryloxy group, a substituted or unsubstituted C7-C30 arylalkyl group, a substituted or unsubstituted C7-C30 alkylaryl group, a substituted or unsubstituted C2-C30 heteroaryl group, a substituted or unsubstituted C2-C30 heteroaryloxy group, a substituted or unsubstituted C3-C30 heteroarylalkyl group, a substituted or unsubstituted C3-C30 alkylheteroaryl group, a substituted or unsubstituted C4-C30 carbocyclic group, a substituted or unsubstituted C5-C30 carbocyclic alkyl group, a substituted or unsubstituted C2-C30 heterocyclic group, or a substituted or unsubstituted C2-C30 heterocyclic alkyl group,
X₁, X₂, and X₃ are each independently —C(═O)O—, —OS(═O)₂O—, —S(═O)₂O—, —S(═O)O—, —OP(═O)(OY)O—, or —P(═O)(OY)O—, and
Y₁ is lithium and Y, Y₂ and Y₃ are each independently a hydrogen atom, an alkali metal, or an ammonium group,
with the proviso that at least one of Y₂ and Y₃ is lithium.

5. The anode interlayer of claim 1, wherein the ion-conductive polymer comprises: a first repeating unit represented by Formula 3, Formula 4, or Formula 5; and a second repeating unit represented by Formula 6: 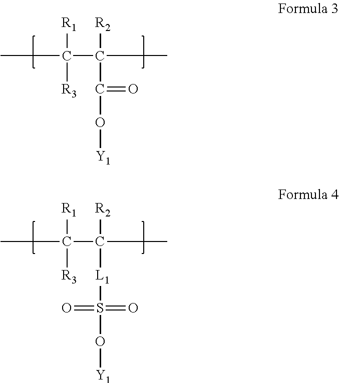 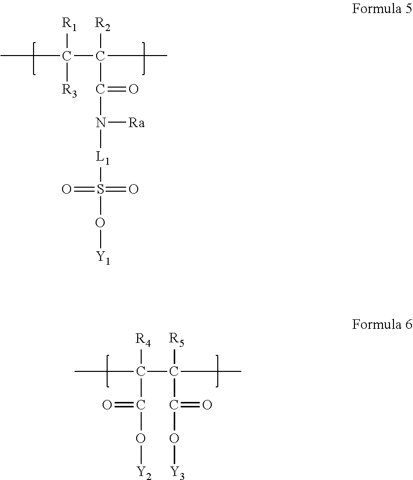
wherein, in Formulae 3, 4, 5, and 6,
R₁, R₂, R₃, R₄, R₅, and Ra are each independently a hydrogen atom, a substituted or unsubstituted C1-C30 alkyl group, a substituted or unsubstituted C1-C30 alkoxy group, a substituted or unsubstituted C2-C30 alkenyl group, a substituted or unsubstituted C2-C30 alkynyl group, a substituted or unsubstituted C6-C30 aryl group, a substituted or unsubstituted C6-C30 aryloxy group, a substituted or unsubstituted C7-C30 arylalkyl group, a substituted or unsubstituted C2-C30 heteroaryl group, a substituted or unsubstituted C2-C30 heteroaryloxy group, a substituted or unsubstituted C3-C30 heteroarylalkyl group, a substituted or unsubstituted C4-C30 carbocyclic group, a substituted or unsubstituted C5-C30 carbocyclic alkyl group, a substituted or unsubstituted C2-C30 heterocyclic group, or a substituted or unsubstituted C2-C30 heterocyclic alkyl group, and
Y₁ is lithium and Y₂ and Y₃ are each independently a hydrogen atom, an alkali metal, or an ammonium group,
with the proviso that at least one of Y₂ and Y₃ is lithium.

6. The anode interlayer of claim 4, wherein the ion-conductive polymer further comprises a third repeating unit represented by Formula 7, a fourth repeating unit represented by Formula 8, or a combination thereof: 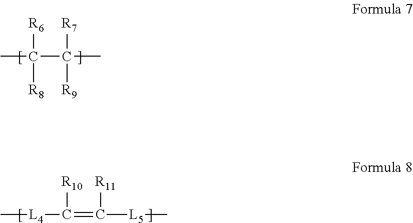
wherein, in Formulae 7 and 8,
L₄ and L₅ are each independently a single bond, a substituted or unsubstituted C1-C30 alkylene group, a substituted or unsubstituted C2-C30 alkenylene group, a substituted or unsubstituted C2-C30 alkynylene group, a substituted or unsubstituted C6-C30 arylene group, a substituted or unsubstituted C6-C30 aryloxy group, a substituted or unsubstituted C7-C30 arylalkylene group, a substituted or unsubstituted C2-C30 heteroarylene group, a substituted or unsubstituted C2-C30 heteroaryloxy group, a substituted or unsubstituted C3-C30 heteroarylalkylene group, a substituted or unsubstituted C4-C30 carbocyclic group, a substituted or unsubstituted C5-C30 carbocyclic alkylene group, a substituted or unsubstituted C2-C30 heterocyclic group, or a substituted or unsubstituted C3-C30 heterocyclic alkylene group,
R₆, R₇, R₈, R₉, R₁₀, and R₁₁ are each independently a hydrogen atom, a substituted or unsubstituted C1-C30 alkyl group, a substituted or unsubstituted C1-C30 alkoxy group, a substituted or unsubstituted C2-C30 alkenyl group, a substituted or unsubstituted C2-C30 alkynyl group, a substituted or unsubstituted C6-C30 aryl group, a substituted or unsubstituted C6-C30 aryloxy group, a substituted or unsubstituted C7-C30 arylalkyl group, a substituted or unsubstituted C2-C30 heteroaryl group, a substituted or unsubstituted C2-C30 heteroaryloxy group, a substituted or unsubstituted C3-C30 heteroarylalkyl group, a substituted or unsubstituted C4-C30 carbocyclic group, a substituted or unsubstituted C5-C30 carbocyclic alkyl group, a substituted or unsubstituted C2-C30 heterocyclic group, or a substituted or unsubstituted C2-C30 heterocyclic alkyl group, and
optionally R₆ and R₇, and R₈ and R₉ are each independently linked to each other to form a ring, the ring being a C6-C10 cycloalkyl group, a C3-C10 heteroaryl group, a fused C3-C10 heteroaryl group, a C3-C10 heterocyclic group, or a fused C3-C10 heterocyclic group.

7. The anode interlayer of claim 4, wherein the ion-conductive polymer further comprises a fifth repeating unit represented by Formula 9, a sixth repeating unit represented by Formula 10, a seventh repeating unit represented by Formula 11, or a combination thereof: 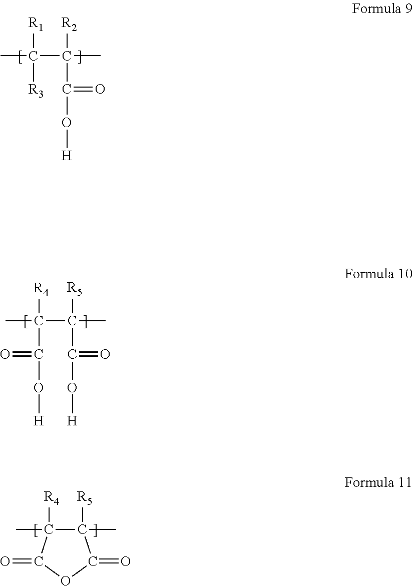
wherein, in Formulae 9, 10, and 11, R₁, R₂, R₃, R₄, and R₅ are each independently a hydrogen atom, a substituted or unsubstituted C1-C30 alkyl group, a substituted or unsubstituted C1-C30 alkoxy group, a substituted or unsubstituted C2-C30 alkenyl group, a substituted or unsubstituted C2-C30 alkynyl group, a substituted or unsubstituted C6-C30 aryl group, a substituted or unsubstituted C6-C30 aryloxy group, a substituted or unsubstituted C7-C30 arylalkyl group, a substituted or unsubstituted C2-C30 heteroaryl group, a substituted or unsubstituted C2-C30 heteroaryloxy group, a substituted or unsubstituted C3-C30 heteroarylalkyl group, a substituted or unsubstituted C4-C30 carbocyclic group, a substituted or unsubstituted C5-C30 carbocyclic alkyl group, a substituted or unsubstituted C2-C30 heterocyclic group, or a substituted or unsubstituted C2-C30 heterocyclic alkyl group.

8. The anode interlayer of claim 1, wherein the ion-conductive polymer comprises an eighth repeating unit represented by Formula 12: 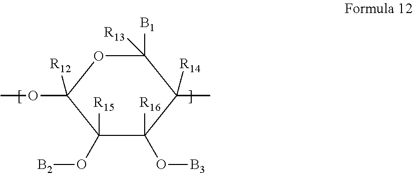
wherein, in Formula 12,
B₁ is -L6-A4-L7-X4-Y₄ or -L6-A4-Y₄,
B₂ is a hydrogen atom or -L8-X5-Y₅,
B₃ is a hydrogen atom or -L9-X6-Y₆,
A4 is a single bond or —O—,
L6, L7, L8, and L9 are each independently a single bond, a substituted or unsubstituted C1-C30 alkylene group, a substituted or unsubstituted C2-C30 alkenylene group, a substituted or unsubstituted C2-C30 alkynylene group, a substituted or unsubstituted C6-C30 arylene group, a substituted or unsubstituted C7-C30 arylalkylene group, a substituted or unsubstituted C2-C30 heteroarylene group, a substituted or unsubstituted C3-C30 heteroarylalkylene group, a substituted or unsubstituted C4-C30 carbocyclic group, a substituted or unsubstituted C5-C30 carbocyclic alkylene group, a substituted or unsubstituted C2-C30 heterocyclic group, or a substituted or unsubstituted C3-C30 heterocyclic alkylene group,
R₁₂, R₁₃, R₁₄, and R₁₅ are each independently a hydrogen atom, a substituted or unsubstituted C1-C30 alkyl group, a substituted or unsubstituted C1-C30 alkoxy group, a substituted or unsubstituted C2-C30 alkenyl group, a substituted or unsubstituted C2-C30 alkynyl group, a substituted or unsubstituted C6-C30 aryl group, a substituted or unsubstituted C6-C30 aryloxy group, a substituted or unsubstituted C7-C30 arylalkyl group, a substituted or unsubstituted C2-C30 heteroaryl group, a substituted or unsubstituted C2-C30 heteroaryloxy group, a substituted or unsubstituted C3-C30 heteroarylalkyl group, a substituted or unsubstituted C4-C30 carbocyclic group, a substituted or unsubstituted C5-C30 carbocyclic alkyl group, a substituted or unsubstituted C2-C30 heterocyclic group, or a substituted or unsubstituted C2-C30 heterocyclic alkyl group,
X4, X5, and X6 are each independently —C(═O)O—, —OS(═O)₂O—, —S(═O)₂O—, —S(═O)O—, —OP(═O)(OY)O—, or —P(═O)(OY)O—, and
Y, Y4, Y5, and Y6 are each independently a hydrogen atom, an alkali metal, or an ammonium group,
with the proviso that at least one of Y4, Y5, and Y6 is lithium.

9. The anode interlayer of claim 8, wherein B₁ is —C(═O)O—Y4, —CH₂—O—CH₂—C(═O)O—Y4, or —CH₂—O—Y4, B₂ is a hydrogen atom or —CH₂—C(═O)O—Y5, B₃ is a hydrogen atom or —CH₂—(C═O)O—Y6, and at least one of Y4, Y5, and Y6 is lithium.

10. The anode interlayer of claim 1, wherein the ion-conductive polymer comprises lithium poly(methacrylic acid), lithium poly(maleic acid), lithium poly(ethylene-alt-maleic acid), lithium poly(isobutylene-alt-maleic acid), lithium poly(butadiene-co-maleic acid), lithium poly(methylvinyl ether-alt-maleic acid), lithium poly(vinylether-alt-maleic acid), lithium poly(2-acrylamido-2-methyl-1-propanesulfonate), lithium poly(styrene sulfonate), lithium carboxymethylcellulose, lithium alginate, lithium polysulfonate fluoropolymer, or a combination thereof.

11. The anode interlayer of claim 1, wherein the electron-conductive polymer comprises poly(3,4-ethylenedioxythiophene):poly(styrenesulfonate), poly(3,4-ethylenedioxythiophene), poly(phenylene sulfide), poly(p-phenylene sulfide), polyaniline, polypyrrole, polyacetylene, poly(p-phenylene), poly(phenylene vinylene), poly(p-phenylene vinylene), poly(thienylene vinylene), polyphenylene, polythiophene, poly(3-alkylthiphene), poly(isothianaphthene), polyfluorene, polyindole, polyazepine, polycarbazole, polyazulene, polyfuran, polyselenophenes, polytellurophene, a derivative thereof, or a combination thereof.

12. The anode interlayer of claim 1, wherein the electron-conductive polymer comprises a water-soluble polymer or a water-dispersible polymer.

13. The anode interlayer of claim 12, wherein the water-soluble polymer or the water-dispersible polymer comprises a π-conjugated backbone and an acidic functional group linked to the backbone, and at least a portion of the acidic functional group comprises lithium as a substituent.

14. The anode interlayer of claim 1, wherein an amount of the first conductive binder is about 1 part to about 20 parts by weight and an amount of the second conductive binder is about 1 part to about 20 parts by weight, each with respect to 100 parts by weight of the material capable undergoing lithiation and delithiation.

15. The anode interlayer of claim 1, wherein a weight ratio between the first conductive binder and the second conductive binder is about 10:90 to about 90:10.

16. The anode interlayer of claim 1, wherein the carbon and the first metal are in the form of particles, and an average particle diameter of the particles is 4 microns or less.

17. The anode interlayer of claim 1, wherein the carbon comprises amorphous carbon, and the first metal comprises silver, silicon, germanium, tellurium, gold, platinum, palladium, aluminum, bismuth, tin, zinc, an alloy thereof, or a combination thereof.

18. The anode interlayer of claim 1, wherein the first metal is in the form of particles, and comprises a conductive coating layer on a surface of the particles, and the conductive coating layer has a thickness of about 1 nanometer to about 10 nanometers.

19. The anode interlayer of claim 1, wherein the material capable of undergoing lithiation and delithiation comprises first particles consisting of amorphous carbon, or comprises a mixture of first particles consisting of amorphous carbon and second particles consisting of the first metal, and an amount of the second particles is about 8 wt % to about 60 wt % based on a total weight of the mixture.

20. The anode interlayer of claim 1, wherein the all-solid secondary battery comprises a cathode active material layer, and
a ratio between a charge capacity of the cathode active material layer and a charge capacity of the anode interlayer satisfies Expression 1:
0.01<b/a<0.5 Expression 1
wherein a is the charge capacity of the anode active material layer, and
b is the charge capacity of the anode interlayer

21. The anode interlayer of claim 1, wherein the anode interlayer has a thickness of about 1 micron to about 20 microns.

22. An all-solid secondary battery comprising: a cathode layer comprising a cathode active material layer; an anode layer; and a solid electrolyte layer between the cathode layer and the anode layer and comprising a solid electrolyte, wherein the anode layer comprises: an anode current collector; and a first anode interlayer between the solid electrolyte layer and the anode current collector, and the first anode interlayer comprises the anode interlayer according to claim 1.

23. The all-solid secondary battery of claim 22, further comprising a second anode interlayer between the solid electrolyte layer and the first anode interlayer, wherein the first anode interlayer is in contact with the solid electrolyte layer.

24. The all-solid secondary battery of claim 23, wherein the second anode interlayer is a metal layer comprising a second metal, an alloy of lithium with the second metal, or a combination thereof, and
the second metal includes silver, silicon, germanium, tellurium, gold, platinum, palladium, aluminum, bismuth, tin, zinc, indium, gallium, titanium, zirconium, niobium, antimony, nickel, iron, cobalt, chromium, magnesium, cesium, lanthanum, a combination thereof, or an alloy thereof.

25. The all-solid secondary battery of claim 23, wherein a thickness of the second anode interlayer is 10% or less of a thickness of the cathode active material layer, and
the second anode interlayer has a thickness of about 10 nanometers to about 500 nanometers, and
a lithium precipitation layer is absent between the solid electrolyte layer and the second anode interlayer.

26. The all-solid secondary battery of claim 22, further comprising, before being charged, a metal layer between the first anode interlayer and the anode current collector, wherein the metal layer comprises lithium metal or a lithium alloy, and the metal layer has a thickness of about 1 micron to about 100 microns.

27. The all-solid secondary battery of claim 22, further comprising a lithium layer between the first anode interlayer and the anode current collector, wherein the plated lithium layer comprises lithium metal or a lithium alloy, and the plated lithium layer has a thickness of about 1 micron to about 100 microns.

28. The all-solid secondary battery of claim 22, wherein a ratio between a charge capacity of the cathode active material layer and a charge capacity of the first anode interlayer satisfies Expression 1:
0.01<b/a<0.5 Expression 1
wherein a is the charge capacity of the anode active material layer, and
b is the charge capacity of the first anode interlayer.

29. The all-solid secondary battery of claim 22, wherein the solid electrolyte comprises an oxide solid electrolyte, a sulfide solid electrolyte, or a combination thereof.

30. A method for charging the all-solid secondary battery of claim 22, the method comprising
charging to exceed a charge capacity of the first anode interlayer,
wherein the all-solid secondary battery is charged so that a lithium precipitation layer precipitated on the anode layer has a thickness of about 1 micron to about 100 microns.
